(19) United States
(12) Patent Application Publication
(10) Pub. No.: US 2025/0245457 A1
(43) Pub. Date: Jul. 31, 2025

(54) CONTROLLER AND CODE READER SYSTEM

(71) Applicant: Keyence Corporation, Osaka (JP)

(72) Inventors: Yusuke HANADA, Osaka (JP); Hiroomi OHORI, Osaka (JP); Hideaki MIYOSHI, Osaka (JP); Fumito EBUCHI, Osaka (JP)

(73) Assignee: Keyence Corporation, Osaka (JP)

(21) Appl. No.: 18/985,152

(22) Filed: Dec. 18, 2024

(30) Foreign Application Priority Data
Jan. 26, 2024 (JP) 2024-010567
Jan. 26, 2024 (JP) 2024-010569
Jan. 26, 2024 (JP) 2024-010574
Jan. 26, 2024 (JP) 2024-010579

(51) Int. Cl. G06K 7/10; H04N 23/61; H04N 23/661

(52) U.S. Cl. CPC G06K 7/10861; G06K 7/1092; H04N 23/61; H04N 23/661

(57) ABSTRACT

Occurrence of a reading error is suppressed even in a case where a conveyance state of a workpiece changes during operation. The controller includes an acquisition unit that acquires a detection signal of the workpiece, a conveyance speed of a conveyor, and installation information indicating relative position and posture of each camera with respect to the conveyor, a recognition unit that recognizes a conveyance state of the workpiece based on the detection signal and the conveyance speed, a processing determination unit that determines a control parameter corresponding to a conveyance position of the workpiece on the conveyor for each camera based on the conveyance state and the installation information of each camera, and a communication unit that transmits the control parameter determined by the processing determination unit to each corresponding camera.

### CROSS-REFERENCE TO RELATED APPLICATIONS

The present application claims foreign priority based on Japanese Patent Application No. 2024-010567, filed Jan. 26, 2024, No. 2024-010569, filed Jan. 26, 2024, No. 2024-010574, filed Jan. 26, 2024, and No. 2024-010579, filed Jan. 26, 2024, the contents of which are incorporated herein by references.

### BACKGROUND OF THE INVENTION

### 1. Technical Field

The disclosure relates to a controller and a code reader system.

### 2. Description of the Related Art

For example, a code reader is configured to capture a code such as a barcode or a two-dimensional code attached to a workpiece conveyed by a conveyor by a camera, cut out the code included in the obtained image by image processing, binarize the code, decode the code, and read information (see, for example, JP2021-149588A).

This type of code reader is used by being connected to a computer as an external control device, a programmable logic controller (PLC), and the like. For example, a user performs various settings such as capturing conditions, image processing, and decoding processing of the code reader by the computer, and setting information set by the user by the computer is transferred to the code reader and is applied at the time of operation. At the time of operation, the code reader performs capturing and decoding processing of the workpiece based on a trigger signal input from the PLC.

Thereafter, the decoding result obtained by the decoding processing is transmitted to the PLC.

However, a conveyance state of the workpiece by a conveyance device is not constantly the same, and it is conceivable that the conveyance state changes with the lapse of time. In this regard, in the code reader of JP2021-149588A, once a capturing condition or the like is set before operation, since the setting continues to be applied during operation, for example, in a case where the conveyance state of the workpiece by the conveyance device changes, capturing processing or the like is not appropriately performed, and thus, there is a concern that a reading error occurs.

### SUMMARY OF THE INVENTION

The disclosure has been made in view of such a point, and an object of the disclosure is to suppress occurrence of a reading error even in a case where a conveyance state of a workpiece changes during operation.

In order to achieve the above object, according to one embodiment of the disclosure, a controller connected to one or a plurality of cameras that generate images based on reflected light from a code attached to a workpiece conveyed on a conveyor and a decoder that executes decoding processing of the code attached to the workpiece based on the images output from the one or plurality of cameras can be assumed.

The controller includes an acquisition unit that acquires a detection signal of the workpiece by a detection sensor, conveyor information including a conveyance speed of the conveyor, and installation information indicating a position and a posture of each camera of the one or plurality of cameras in a conveyor coordinate system, a recognition unit that recognizes a conveyance state of the workpiece based on the detection signal and the conveyance speed, a processing determination unit that determines a control parameter corresponding to a conveyance position of the workpiece on the conveyor for each camera based on the conveyance state and the installation information of each camera, and a communication unit that transmits the control parameter determined by the processing determination unit to each corresponding camera.

According to this configuration, when the image of the code attached to the workpiece conveyed on the conveyor is acquired by the camera, the control parameter of the camera is dynamically determined based on the conveyance state of the workpiece recognized by the recognition unit and the installation information of the camera. For example, in a case where the conveyance state of the workpiece changes during operation, since the control parameter of the camera is determined based on the changed conveyance state, the capturing processing by the camera can be executed by the control parameter suitable for the changed conveyance state. As a result, the occurrence of the reading error is suppressed even in a case where the conveyance state of the workpiece changes during operation.

According to another embodiment of the disclosure, a controller connected to one or a plurality of code readers via communication can be assumed. Each of the code readers includes an illumination control unit that controls an illumination unit that irradiates a workpiece conveyed on a conveyor, a camera that generates images based on reflected light from a code attached to the workpiece, and a decoder that executes decoding processing of the code attached to the workpiece based on the images output from the camera. In this case, the controller may include an acquisition unit that acquires a detection signal of the workpiece by a detection sensor, a conveyance speed of the conveyor, and installation information indicating a position and a posture of each code reader of the one or plurality of code readers in a conveyor coordinate system of the conveyor, a recognition unit that recognizes a conveyance state of the workpiece based on the detection signal and the conveyance speed, a processing determination unit that determines a control parameter corresponding to a conveyance position of the workpiece on the conveyor for each code reader based on the conveyance state and the installation information of each code reader, and a communication unit that transmits the control parameter determined by the processing determination unit to each corresponding code reader.

According to still another embodiment of the disclosure, a code reader system that reads a code attached to a workpiece downstream of a detection sensor that detects the workpiece conveyed on a conveyor based on a detection signal from the detection sensor can be assumed. The code reader system may include one or a plurality of code readers each including an illumination control unit that controls an illumination unit that irradiates the workpiece, a camera that generates images based on reflected light from the workpiece, and a decoder that executes decoding processing of the code attached to the workpiece based on the images generated by the camera, and a controller that includes an acquisition unit that acquires the detection signal, a conveyance speed of the conveyor, and installation information indicating a position and a posture of each code reader of the one or plurality of code readers in a conveyor coordinate system of the conveyor, a recognition unit that recognizes a conveyance state of the workpiece based on the detection signal and the conveyance speed, a processing determination unit that determines a control parameter corresponding to a conveyance position of the workpiece on the conveyor for each code reader based on the conveyance state and the installation information of each code reader, and a communication unit that transmits the control parameter determined by the processing determination unit to each corresponding code reader.

As described above, since the control parameter of the camera can be dynamically determined during operation, the occurrence of the reading error can be suppressed even in a case where the conveyance state of the workpiece changes.

### BRIEF DESCRIPTION OF THE DRAWINGS

FIG. 1 is a schematic configuration diagram of a code reader system according to an embodiment of the invention;

FIG. 2 is a diagram for describing Operation Example 1 of the code reader system;

FIG. 3 is a plan view for describing Operation Example 2 of the code reader system;

FIG. 4A is a plan view for describing Operation Example 2 of the code reader system;

FIG. 4B is a side view for describing Operation Example 2 of the code reader system;

FIG. 5 is a block diagram of a code reader;

FIG. 6 is a diagram illustrating each positional relationship from a trigger point to an output point;

FIG. 7 is a diagram illustrating an example of a connection form between a controller and the code reader;

FIG. 8 is a diagram for describing a positional relationship between the code reader and a conveyance device;

FIG. 9 is a block diagram of the controller;

FIG. 10 is a timing chart in a case where a plurality of code readers are provided;

FIG. 11 is a diagram for describing details of the timing chart illustrated in FIG. 10;

FIG. 12 is a timing chart in a case where illumination units of a plurality of code readers are simultaneously turned on;

FIG. 13 is a timing chart in a case where an illumination cycle and a capturing cycle are common to all code readers;

FIG. 14 is a timing chart in a case where the illumination cycle and the capturing cycle are different for each code reader, but are common in units of code readers;

FIG. 15 is a timing chart in a case where the illumination cycle and the capturing cycle are different for each code reader in units of code readers;

FIG. 16 is a diagram for describing a capturing region in a case where a plurality of workpieces approach in a conveyance direction;

FIG. 17 is a diagram for describing a mask region in a case where the plurality of workpieces approach in the conveyance direction;

FIG. 18 is a diagram illustrating a capturing region in a case where a custom sensor is used;

FIG. 19 is a diagram illustrating a reading direction of the custom sensor;

FIG. 20 is a diagram illustrating installation information acquired by an acquisition unit at the time of calibration;

FIG. 21 is a diagram illustrating a calculation result of a position and an installation angle of each code reader in a coordinate system of the conveyance device;

FIG. 22 is a diagram illustrating camera information acquired by the acquisition unit at the time of calibration;

FIG. 23 illustrates a transformation expression used when a coordinate system of the conveyance device is transformed into a coordinate system of a capturing unit;

FIG. 24 illustrates a transformation expression used when the coordinate system of the capturing unit is transformed into a coordinate system of an image sensor;

FIG. 25 is a diagram illustrating an example of a calibration model;

FIG. 26 is a diagram corresponding to FIG. 25 after a change of a position parameter of the code reader is accepted;

FIG. 27 is a diagram corresponding to FIG. 25 illustrating an example in which an image of a conveyed workpiece is displayed;

FIG. 28 is a diagram corresponding to FIG. 27 in a case where an edge display line is aligned with the workpiece;

FIG. 29 is a diagram corresponding to FIG. 25 in a case where the code reader is installed so as to capture from an upstream side on a side of the workpiece;

FIG. 30 is a diagram corresponding to FIG. 29 illustrating an example in which the image of the conveyed workpiece is displayed;

FIG. 31 is a diagram corresponding to FIG. 25 in a case where the code reader is installed so as to capture from a downstream side on the side of the workpiece;

FIG. 32 is a diagram corresponding to FIG. 31 illustrating an example in which the image of the conveyed workpiece is displayed;

FIG. 33 is a diagram according to a modification in a case where the code reader is installed so as to capture from the upstream side on the side of the workpiece;

FIG. 34 is a diagram corresponding to FIG. 33 illustrating an example in which the image of the conveyed workpiece is displayed;

FIG. 35 is a diagram according to a modification in a case where the code reader is installed so as to capture from the downstream side on the side of the workpiece;

FIG. 36 is a diagram corresponding to FIG. 35 illustrating an example in which the image of the conveyed workpiece is displayed;

FIG. 37 is a block diagram of a collection and analysis device;

FIG. 38 is a flowchart illustrating an example of a flow of processing from capturing to image storage;

FIG. 39 is a diagram illustrating an example of an image displaying user interface screen;

FIG. 40 is a flowchart illustrating an example of a procedure until a log is additionally written after decoding processing;

FIG. 41 is a block diagram illustrating a case where images are accumulated in each collection and analysis device;

FIG. 42 is a flowchart illustrating an example of a control flow of the controller at the time of setting the code reader system; and

FIG. 43 is a flowchart illustrating an example of the control flow of the controller at the time of operation of the code reader system.

### DETAILED DESCRIPTION

Hereinafter, embodiments of the invention will be described in detail with reference to the drawings. Note that, the following description of preferred embodiments is merely exemplary in nature and is not intended to limit the invention, the application thereof, or the use thereof.

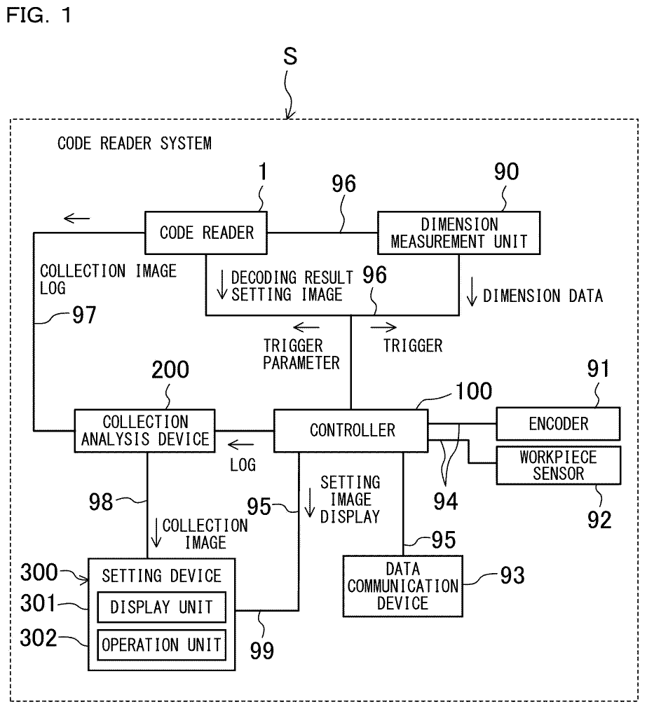

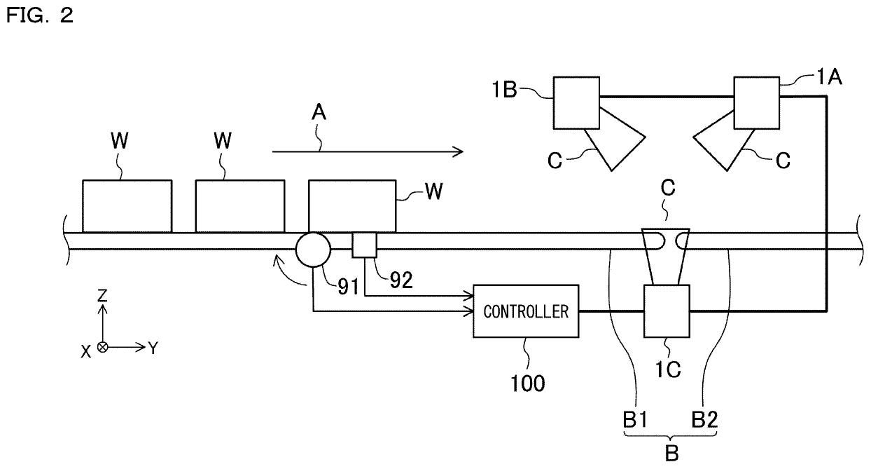

FIG. 1 is a diagram illustrating a schematic configuration of a code reader system S including a code reader 1 according to an embodiment of the invention. FIGS. 2, 3, 4A, and 4B are diagrams for describing Operation Examples 1 and 2 of the code reader system S. In Operation Examples 1 and 2, a case where the code reader system S is used in a distribution site that handles a plurality of workpieces W is illustrated. In the distribution site, a conveyance device B for sequentially conveying the plurality of workpieces W in a predetermined conveyance direction is installed. The conveyance direction of the workpiece W is indicated by an arrow A in FIG. 2. Therefore, a left side in FIGS. 2, 3, 4A, and 4B is an upstream side in the conveyance direction, and a right side is a downstream side in the conveyance direction.

As illustrated in FIG. 2, the conveyance device B includes a plurality of conveyance mechanisms B1 and B2. The conveyance mechanisms B1 and B2 are, for example, a belt conveyor, a roller conveyor, or the like, and include an upstream-side conveyance mechanism B1 and a downstream-side conveyance mechanism B2. Upper surfaces of the upstream-side conveyance mechanism B1 and the downstream-side conveyance mechanism B2 are conveyance surfaces. In this embodiment, the conveyance direction of the workpiece W is defined as a Y direction, a direction orthogonal to the Y direction on the conveyance surface is defined as an X direction, and a direction orthogonal to both directions of the X direction and the Y direction is defined as a Z direction. In the distribution site, the X direction and the Y direction may be substantially horizontal, but the Y direction may be inclined with respect to a horizontal plane. The X direction can be referred to as a width direction of the conveyance mechanisms B1 and B2, or can be referred to as a longitudinal direction of a gap of the conveyance device B. In addition, the Z direction can also be referred to as a height direction (up-down direction). Note that, the definition of the direction is a definition for the sake of convenience in description, and does not limit the direction at the time of use.

The upstream-side conveyance mechanism B1 and the downstream-side conveyance mechanism B2 are provided at an interval in the conveyance direction. A size (dimension) of the interval between the upstream-side conveyance mechanism B1 and the downstream-side conveyance mechanism B2 is not particularly limited, but is set such that a smallest workpiece W to be conveyed is smoothly transferred from the upstream-side conveyance mechanism B1 to the downstream-side conveyance mechanism B2 without falling from the gap. A dimension of the gap in a longitudinal direction (a dimension in the X direction) is about the same as a width of the conveyance mechanisms B1 and B2 (a dimension in the X direction), but these dimensions are also not particularly limited.

The number of code readers 1 included in the code reader system S may be one or more. The code reader 1 of the present embodiment is a stationary type. The time of operation of the stationary-type code reader 1 is a time when an operation of sequentially reading codes of the workpieces W conveyed by the conveyance device B is performed. The code reader 1 is fixed to a frame, a table, a bracket, or the like (not illustrated). In the present embodiment, a case where the code reader system S includes the plurality of code readers 1 will be described. In Operation Example 1 illustrated in FIG. 2, three code readers 1 are used, and fields of view of the code readers 1 are indicated by reference numeral C.

In a case where the plurality of code readers 1 are provided, the plurality of code readers 1 can be installed so as to surround the workpieces W. That is, the code readers 1 of Operation Example 1 include an upstream-side oblique reading code reader 1A installed so as to be able to read codes given to the workpieces W from the upstream side above the workpieces W, a downstream-side oblique reading code reader 1B installed so as to be able to read codes given to the workpieces W from the downstream side above the workpieces W, and a bottom-surface reading code reader 1C. The bottom-surface reading code reader 1C is installed below the conveyance device B such that a gap between the upstream-side conveyance mechanism B1 and the downstream-side conveyance mechanism B2 is included in the field of view C.

Since the gap between the upstream-side conveyance mechanism B1 and the downstream-side conveyance mechanism B2 is included in the field of view C of the bottom-surface reading code reader 1C, when a bottom surface of the workpiece W being conveyed passes through the gap, the bottom surface can be captured by the code reader 1C. The code may be given to the bottom surface of the workpiece W. In a case where the code is given to the bottom surface of the workpiece W, since the code reader 1 is installed at an installation position below the conveyance surface of the conveyance device B, the code attached to the bottom surface of the workpiece W can be read from below the conveyance surface of the conveyance device B through the gap.

A capturing unit 3 of the bottom-surface reading code reader 1C is a bottom-surface camera, and outputs a plurality of images on which a part of the code attached to the bottom surface of the workpiece W appears by continuously capturing the bottom surface of the workpiece W exposed from the gap of the conveyance device B and included in a depth of field of the capturing unit 3. After a plurality of images on which a part of the code in the conveyance direction is captured are sequentially output from an image sensor 31b, a code image given to the bottom surface of the workpiece W can be acquired by combining these images.

A plurality of bottom-surface reading code readers 1C can be installed. In this case, a plurality of capturing units 3 that read the common gap of the conveyance device B from below the conveyance surface of the conveyance device B and a plurality of illumination units 2 corresponding to the plurality of capturing units 3 can be provided.

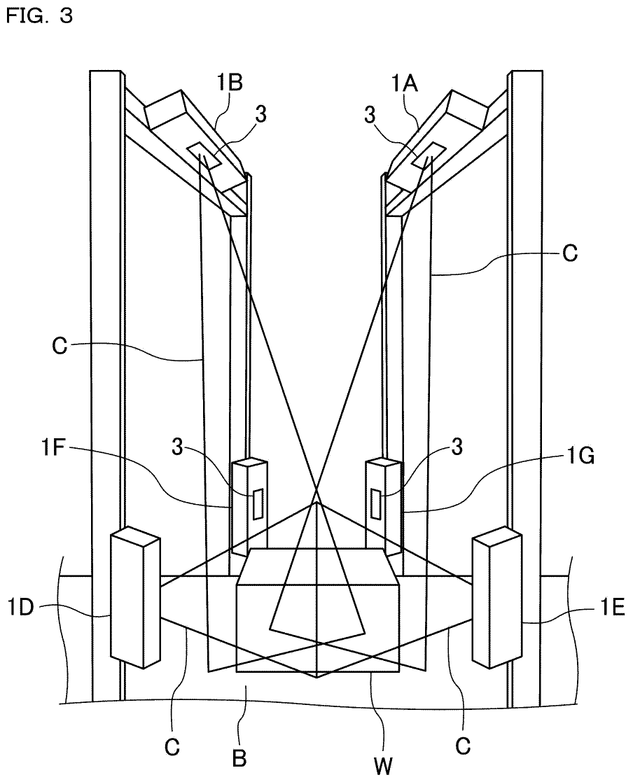

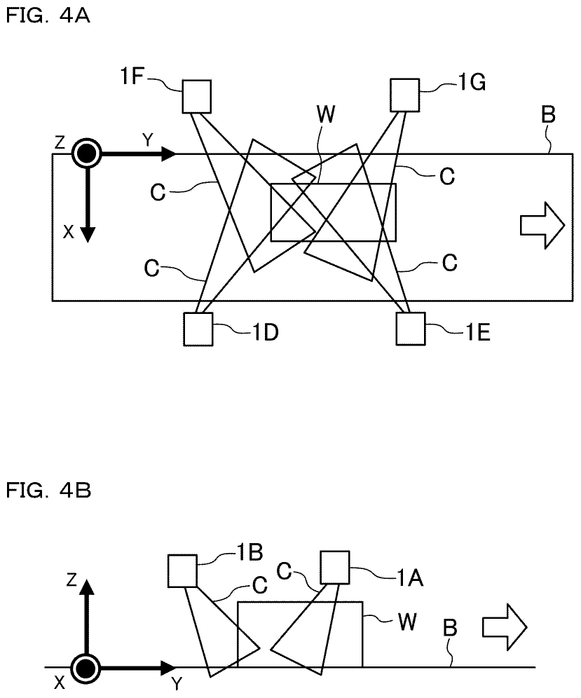

FIG. 3 illustrates the arrangement of code readers 1A, 1B, 1D, 1E, 1F, and 1G in Operation Example 2. FIG. 4A illustrates a scene in which the code readers 1D to 1G of Operation Example 2 are viewed from above a conveyance device B, and FIG. 4B illustrates a scene in which the code readers 1A and 1B of Operation Example 2 are viewed from a side of the conveyance device B. In Operation Example 2, six code readers are used. Specifically, the code reader 1A captures an upper surface and a front surface of the workpiece W, the code reader 1B captures the upper surface and a rear surface of the workpiece W, the code reader 1D captures a side surface (right side in the conveyance direction) and the rear surface of the workpiece W, the code reader 1E captures the side surface (right side in the conveyance direction) and the front surface of the workpiece W, the code reader 1F captures a side surface (left side in the conveyance direction) and the rear surface of the workpiece W, and the code reader 1G captures the side surface (left side in the conveyance direction) and the front surface of the workpiece W.

The code reader system in the present embodiment is not limited to Operation Examples 1 and 2, and Operation Examples 1 and 2 can be voluntarily combined. For example, in Operation Example 2, the bottom-surface reading code reader 1C of Operation Example 1 may be additionally installed. The code reader 1 can be installed at an installation location other than Operation Examples 1 and 2. In Operation Examples 1 and 2, the plurality of code readers 1 can capture different workpiece surfaces of the workpiece W.

The code attached to the workpiece W includes both a barcode and a two-dimensional code. Examples of the two-dimensional code include a QR code (registered trademark), a micro QR code, and a data matrix (data code), Veri code, Aztec code, PDF417, Maxi code, and the like. The two-dimensional code includes a stack type and a matrix type, but the invention can be applied to any two-dimensional code. The code may be given by being directly printed or imprinted on the workpiece W, or may be given by being sticked to the workpiece W after being printed on a label, and means and methods therefor are not limited. In addition, in a case where the plurality of code readers 1 are used, all the code readers may be the same code reader or different code readers. In the following description, it is assumed that all the code readers 1 are the same code reader.

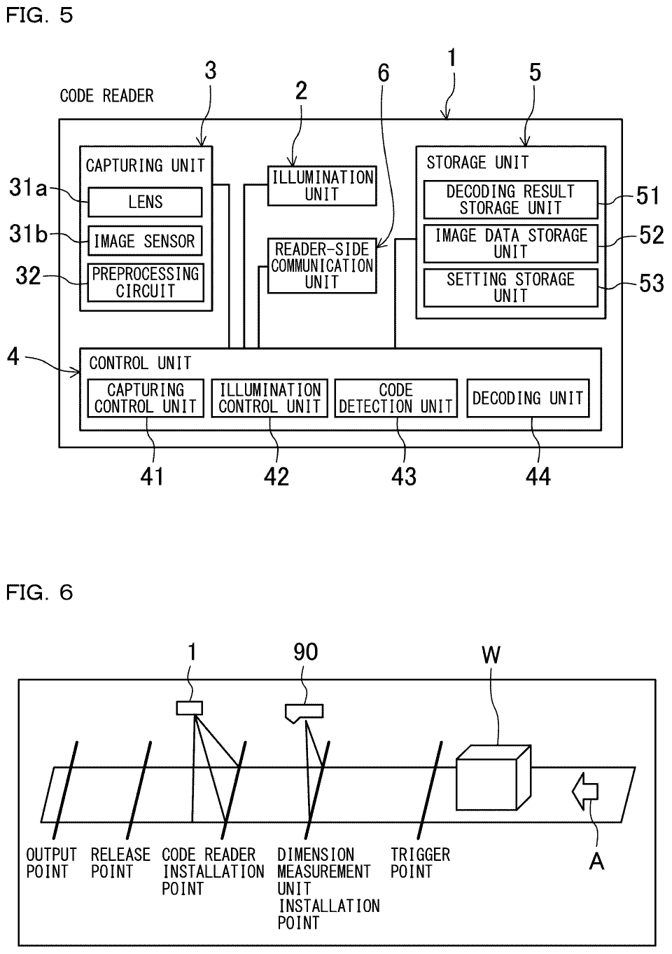

FIG. 5 is a block diagram of the code reader 1. The code reader 1 includes the illumination unit 2, the capturing unit (camera) 3, a control unit 4, a storage unit 5, and a reader-side communication unit 6. The control unit 4 includes a capturing control unit 41 that controls the capturing unit 3, an illumination control unit 42 that controls the illumination unit 2, a code detection unit 43, and a decoding unit (decoder) 44. In addition, the storage unit 5 includes a decoding result storage unit 51, an image data storage unit 52, and a setting storage unit 53. The decoding result storage unit 51, the image data storage unit 52, and the setting storage unit 53 can be provided as, for example, a readable and writable storage device such as a solid-state drive (SSD). Although not illustrated, the decoding result storage unit 51, the image data storage unit 52, and the setting storage unit 53 may be provided as separate storage devices.

The reader-side communication unit 6 is a unit that executes communication with various external devices (details will be described later). The control unit 4 receives setting information and the like transmitted from the external device via the reader-side communication unit 6. In addition, the control unit 4 receives a reading start trigger signal from the external device via the reader-side communication unit 6. A decoding result by the code reader 1 is transmitted to the external device via the reader-side communication unit 6. In addition, the reader-side communication unit 6 also receives, for example, a dimension of the gap formed between the plurality of conveyance mechanisms B1 and B2 included in the conveyance device B, a conveyance speed of the conveyance device B, and the like. The dimension of the gap and the conveyance speed can be input in advance by a user in the external device. The input dimension of the gap and conveyance speed are stored in the external device, and the dimension of the gap and the conveyance speed are transmitted from the external device and are then received and acquired by the reader-side communication unit 6.

The illumination unit 2 is a unit that irradiates the workpiece W conveyed on the conveyance device B with illumination light rays. In the case of Operation Example 1 illustrated in FIG. 2, since the bottom-surface reading code reader 1C is installed below the conveyance surface of the conveyance device B, the illumination unit 2 irradiates the gap between the upstream-side conveyance mechanism B1 and the downstream-side conveyance mechanism B2 with the illumination light rays from below the conveyance surface. As a result, when the bottom surface of the workpiece W being conveyed passes through the gap between the upstream-side conveyance mechanism B1 and the downstream-side conveyance mechanism B2, the bottom surface can be illuminated by the illumination unit 2. In a case where the code is given to the bottom surface of the workpiece W, the code attached to the bottom surface of the workpiece W can be illuminated by the illumination unit 2. The illumination unit 2 includes a light emitter including, for example, a light emission diode (LED).

The illumination unit 2 and the capturing unit 3 may be integrated, or the illumination unit 2 and the capturing unit 3 may be separated. The illumination unit 2 is controlled by the illumination control unit 42 to be switched between turned-on and turned-off, change brightness at the time of being turned on, and the like. When the reading start trigger signal is input from the external device, the illumination control unit 42 turns on the illumination unit 2 for a predetermined time and turns off the illumination unit 2 after a predetermined time has elapsed.

The capturing unit 3 is a unit that generates an image based on reflected light from the code attached to the workpiece W conveyed on the conveyance device B. The capturing unit 3 can generate the code image including the code by capturing the workpiece W and can output the code image to the control unit 4. The capturing unit 3 includes a lens 31a, the image sensor 31b, and a preprocessing circuit 32. The lens 31a is an image forming lens that collects reflected light from the workpiece W. Light incident on the lens 31a is emitted toward a light receiving surface of the image sensor 31b and forms an image on the light receiving surface.

The image sensor 31b includes a light receiving element such as a charge-coupled device (CCD) or a complementary metal-oxide-semiconductor (CMOS) that converts an image of the code obtained through the lens 31a into an electrical signal. The image including the code is generated based on a light reception amount of light received by the light receiving surface of the image sensor 31b. The image sensor 31b includes a plurality of capturing elements arranged in a row direction and a column direction, that is, a plurality of pixels arrayed in a matrix. That is, the capturing unit 3 is a so-called area camera. In the present embodiment, the number of pixels in the column direction (U direction) is larger than the number of pixels in the row direction (V direction) in the image sensor 31b. The number of pixels, a focal length, a sensor size, and the like of the image sensor 31b are stored, as camera information regarding the capturing unit 3, in the storage unit 5. A captured image (hereinafter, also simply referred to as an “image”) generated by capturing the workpiece W or the like by the image sensor 31b is input to the preprocessing circuit 32. The preprocessing circuit 32 may be provided as necessary, and is not essential.

The preprocessing circuit 32 is, for example, an integrated circuit such as a field-programmable gate array (FPGA), and is a unit that executes various kinds of preprocessing on the image output from the image sensor 31b. The preprocessing includes, for example, various kinds of filter processing. The capturing unit 3 outputs an image preprocessed by the preprocessing circuit 32 to the control unit 4. The preprocessing by the preprocessing circuit 32 may be executed as necessary, and an image without preprocessing may be output to the control unit 4. The image output to the control unit 4 is stored in the image data storage unit 52.

The capturing unit 3 is controlled by the capturing control unit 41. When the reading start trigger signal is input from the external device, the capturing control unit 41 generates an image by performing exposure for a preset exposure time. The capturing control unit 41 also controls the capturing unit 3 to execute processing of applying a preset gain to the image generated by the image sensor 31b and amplifying brightness of the image by digital image processing.

The control unit 4 is a unit that controls the units of the code reader 1 to detect the code attached to the workpiece W based on the plurality of images output from the capturing unit 3, and execute decoding processing of the detected code. As a specific configuration example of the control unit 4, for example, a configuration example including a microcomputer including a processor (having a function as a central processing unit), a ROM, a RAM, and the like can be exemplified. The capturing control unit 41, the illumination control unit 42, the code detection unit 43, and the decoding unit 44 are constituted by hardware included in the control unit 4, software executed by the control unit 4, and the like.

The code detection unit 43 of the control unit 4 is a unit that specifies a code region based on the code image output from the capturing unit 3 and detects the code from the specified code region. The code detection unit 43 generates a plurality of edge images by applying a plurality of edge extraction filters for extracting edges of different frequencies to the image generated by the capturing unit 3, and then executes integration processing of the plurality of edge images. Thereafter, the code detection unit 43 determines code candidate positions based on the result of the edge integration processing. That is, on the edge-processed image, a region where many pixels having large luminance values gather can be estimated as the code region.

For example, in order to search for a position of the code in the code image, the code detection unit 43 can generate a heat map image indicating code likeness. That is, the code detection unit 43 quantifies a characteristic amount of the code, generates a heat map in which a magnitude of the characteristic amount is assigned to each pixel value, and extracts a code candidate region where there is a high possibility that there is a code on the heat map. As a specific example, there is a method for acquiring a characteristic portion of the code in a region that is relatively hot (has a large characteristic amount) on the heat map. In a case where a plurality of characteristic portions are acquired, the characteristic portions can be preferentially extracted and stored in the RAM or the like. The heat map image is used, and thus, the code region can be detected at a high speed.

The decoding unit 44 of the control unit 4 is a unit that decodes the code detected by the code detection unit 43, and specifically, since the code is represented by black-and-white binarized data, the decoding unit decodes the black-and-white binarized data. For decoding, a table representing a contrast relationship of encoded data can be used. Further, the decoding unit 44 checks whether or not the decoded result is correct according to a predetermined check method. In a case where an error is found in the data, correct data is calculated by using an error correction function. The error correction function varies depending on a type of the code.

As illustrated in FIG. 1, the code reader system S includes a dimension measurement unit 90, an encoder 91, a workpiece sensor 92, a data communication device 93, a controller 100, a collection and analysis device 200, a setting device 300, and the like in addition to the code reader 1. The dimension measurement unit 90, the controller 100, the collection and analysis device 200, and the like are examples of the external device.

The setting device 300 is, for example, a personal computer or the like, and includes a display unit (display device) 301 constituted by a liquid crystal display or the like, and an operation unit 302 constituted by various input devices or operation devices such as a keyboard and a mouse. The user can input various kinds of information by operating the operation unit 302. In a case where the collection and analysis device 200 is the personal computer, the setting device 300 does not need to be the personal computer, and may be a combination of a display and an input device. Note that, in the description of the present embodiment, the code reader system S having a function of decoding the code will be described, but the invention can also be applied to a device or a system that does not have a function of decoding the code. For example, in the case of a system in which the decoding unit 44 to be described later is omitted or inoperable, the system is an image processing device or an image processing system that executes various kinds of image processing by using the image generated by capturing the workpiece W.

The encoder 91 and the workpiece sensor 92 are connected to communicate with the controller 100 via an IO wiring 94. The data communication device 93 is connected to communicate with the controller 100 via a host communication line 95, and includes a device that executes communication with an external network or the like. The code reader 1 and the dimension measurement unit 90 are connected to communicate with the controller 100 by a dedicated control communication line 96.

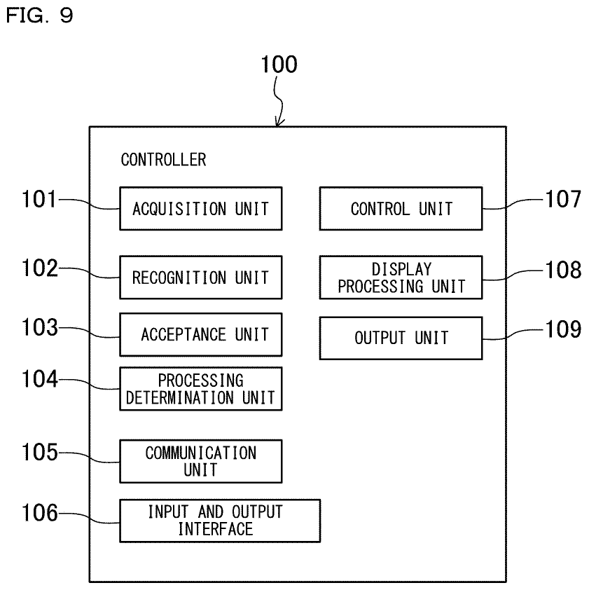

Since the code reader 1 includes the capturing unit 3 and the decoding unit 44, the capturing unit 3 and the decoding unit 44 are connected to the controller 100. In addition, since the code reader 1 includes the illumination unit 2 corresponding to the capturing unit 3, the illumination unit 2 is connected to the controller 100. Although details will be described later, in the case of Operation Examples 1 and 2, the capturing units 3 of the plurality of code readers 1 capture the workpiece W from a plurality of different directions in response to an instruction from a control unit 107 (illustrated in FIG. 9) of the controller 100. The illumination units 2 of the plurality of code readers 1 illuminate the workpiece W from the plurality of different directions in response to the instruction from the control unit 107 of the controller 100.

In addition, the code reader 1 and the dimension measurement unit 90 are connected to each other through the dedicated control communication line 96 so as to be able to communicate with each other. Further, the code reader 1 is connected to communicate with the collection and analysis device 200 via a communication line 97. The setting device 300 is connected to communicate with the collection and analysis device 200 via a communication line 98, and is connected to communicate with the controller 100 via a communication line 99. Although details will be described later, the collection and analysis device 200 is a unit that collects and stores a time-series log including the image transmitted from the controller 100 or the code reader 1, and is typically a personal computer. Note that, a connection form of the code reader 1, the dimension measurement unit 90, the encoder 91, the workpiece sensor 92, the data communication device 93, the controller 100, the collection and analysis device 200, and the setting device 300 described above is an example, and any connection form that can realize functions to be described later may be used.

The dimension measurement unit 90 is, for example, an optical dimension measuring device, and is an example of a detection sensor capable of detecting workpiece information including at least one of a position of the workpiece W in the width direction of the conveyance device B and a height of the workpiece W. As the optical dimension measuring device constituting the dimension measurement unit 90, a known device of the related art can be used, and for example, dimensions of the workpiece W can be measured by the principle of triangulation by irradiating the workpiece W with measurement light and receiving the measurement light reflected from the workpiece W. The dimensions of the workpiece W that can be measured by the dimension measurement unit 90 include, for example, a height, a width, a depth, and the like. When the reading start trigger signal transmitted from the controller 100 is received via the dedicated control communication line 96, the dimension measurement unit 90 executes dimension measurement processing. The dimension measurement unit 90 transmits the generated dimension data to the controller 100 and the code reader 1 via the dedicated control communication line 96. The dimensions of the workpiece W are measured, and thus, for example, estimation of a loading capacity for loading the workpieces W and calculation of a transportation amount can be performed.

The encoder 91 is a device for detecting the conveyance speed of the conveyance device B. As illustrated in FIG. 2, the encoder 91 is attached to the conveyance device B. In addition, the workpiece sensor 92 is a device (for example, a photoelectric sensor) for detecting that the workpiece W conveyed by the conveyance device B reaches a predetermined position, and outputs a detection signal when the fact that the workpiece W reaches the predetermined position is detected. The workpiece sensor 92 can also be attached to the conveyance device B. Signals output from the encoder 91 and the workpiece sensor 92 are transmitted to the controller 100 via the IO wiring 94.

FIG. 6 is a diagram illustrating each positional relationship from a trigger point to an output point. The trigger point is a point at which a reading start trigger signal for executing capturing and illumination is output. For example, a point in time at which the workpiece sensor 92 detects that the workpiece W reaches a predetermined position can be set as the trigger point, and the reading start trigger signal can be output to the dimension measurement unit 90 and the code reader 1 via the dedicated control communication line 96 at the trigger point. The workpiece sensor 92 is installed on the upstream side with respect to the code reader 1 in the conveyance direction. Therefore, the code reader 1 reads the code attached to the workpiece W downstream of the workpiece sensor 92.

The dimension measurement unit 90 is installed at a dimension measurement unit installation point downstream of the trigger point in the conveyance direction. Therefore, the dimensions of the workpiece W arriving after the reading start trigger signal is output can be measured. The code reader 1 is installed at a code reader installation point on the downstream side of the dimension measurement unit installation point in the conveyance direction. Therefore, it is possible to capture the workpiece W whose dimensions have been measured by the dimension measurement unit 90.

The decoding processing of the code of the workpiece W is executed after the reading start trigger signal is input, and the decoding processing and creation of output data including the decoding result, the log, and the like are executed up to a release point. When the workpiece W reaches the output point, the output data is output from the code reader 1 to the data communication device 93 via the dedicated control communication line 96. The output point corresponds to, for example, a user-desired timing determined based on specifications of another system. The output point and the release point may be set at the same timing. Whether or not the workpiece W has reached the release point and the output point can also be detected by the workpiece sensor.

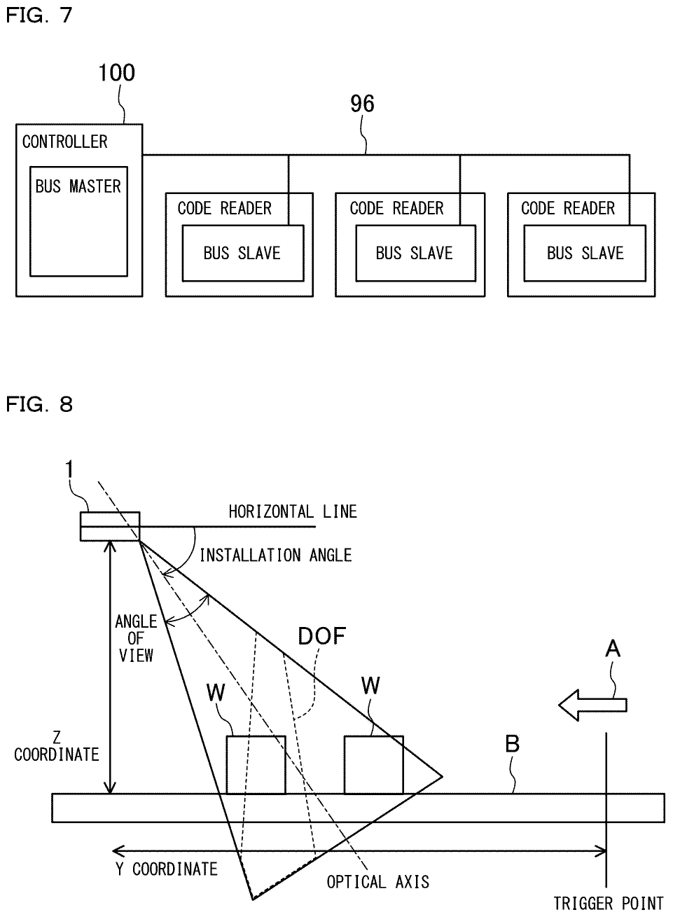

As illustrated in FIG. 7, in a case where the plurality of code readers 1 are operated, the controller 100 is connected to communicate with the plurality of code readers 1 via the dedicated control communication line 96. In this case, the controller 100 serves as a bus master, and each code reader 1 serves as a bus slave. The dedicated control communication line 96 can also be referred to as a bus used for realizing transmission and reception of various kinds of data between the bus master and the bus slave. In addition to the example in which the plurality of code readers 1 are directly connected to the controller 100, a ring network is constructed by directly connecting the code readers 1 to each other, and thus, even in a case where the direct connection between a certain code reader 1 and the controller 100 is disconnected, the connection between the code reader 1 and the controller 100 can be maintained via another code reader 1.

FIG. 8 is a diagram for describing a positional relationship between the code reader 1 and the conveyance device B. In a coordinate system (conveyor coordinate system) of the conveyance device B, for example, a position of the workpiece sensor 92 can be defined as an origin, the conveyance direction can be defined as the Y direction, the width direction of the conveyor can be defined as the X direction, and the height direction from the conveyance surface can be defined as the Z direction. An installation angle of the code reader 1 is determined by an angle between the conveyance surface (Y direction) and an optical axis. An angle of view of the code reader 1 is determined in advance for each model of the code reader 1. An X coordinate, a Y coordinate, a Z coordinate, an installation angle, an angle of view, and the like of the code reader 1 are installation information indicating a position and a posture of the capturing unit 3 in a conveyor coordinate system, and include an installation position and an installation angle of the capturing unit 3 in the coordinate system of the conveyance device B. The code reader 1 has, for example, a Scheimpflug optical system including the lens 31a that collects reflected light from the code attached to the workpiece W and the image sensor 31b having a light receiving surface inclined with respect to an optical axis of the lens 31a, and includes the capturing unit 3 (camera) that generates and outputs the image including the code based on the light reception amount received by the light receiving surface. The capturing unit 3 has a depth of field DOF suitable for oblique reading by the Scheimpflug optical system. Note that, the optical system of the capturing unit 3 is not limited to the Scheimpflug optical system.

In addition to the code reader 1 and the dimension measurement unit 90, the controller 100 is configured to be connectable to an external controlled device, for example, such as a packing style camera that captures a packing style of the workpiece W, and is a controller that controls trigger control of the code reader 1, the dimension measurement unit 90, and the external controlled device. When a signal output from the workpiece sensor 92 that detects the position of the workpiece W or the encoder 91 for tracking the workpiece W is received, the controller 100 outputs a control parameter, a reading start trigger signal, and the like to the code reader 1, the dimension measurement unit 90, and the external controlled device. In addition, the decoding results from the code readers 1 are aggregated and uploaded to the collection and analysis device 200, the setting device 300, and the like.

Logic of the trigger control includes delay setting from a point in time at which the workpiece sensor 92 detects the workpiece W, and the like, and such setting can be performed by the controller 100. In addition, processing (character string operation or the like) of the read data can be executed by the controller 100. Therefore, the controller 100 has setting and programming elements, and is configured to be able to cope with protocol specifications of different host communication (TCP/IP socket communication or legacy serial) according to an installation site.

Here, in an actual operation site, there are various installation locations of the code reader 1, and it may be difficult to change the setting of the code reader 1 by operating the code reader 1 after installation. In addition, in a case where individual IDs are set for the code readers 1 before the plurality of code readers 1 are installed and then the code readers 1 are arranged in prescribed locations, there are restrictions on installation. For example, in a case where the code readers 1 are installed in wrong locations, it is difficult to reset the IDs of the code readers 1. In addition, a person who installs the code reader 1 may be different from a person who sets the code reader 1, and it is desired to eliminate the restrictions on installation as much as possible.

In addition, the same applies to IP addresses, and problems in a case where the code readers 1 are installed after the IP addresses are set in advance are as described above. Even after the installation of the code readers 1, in a case where the IP addresses have not been set, DHCP can be used. However, in a case where other IP addresses have already been allocated to the code readers 1, since it cannot be handled without returning to the unset state, physical means such as an IP address initialization button is required. Further, there is also a use case where Ethernet is not used (a case where an image is not required), and it is necessary to enable the Ethernet even in a state where the IP addresses have not been allocated to the code readers 1.

In contrast, in the standard of the dedicated control communication using the dedicated control communication line 96 according to the present embodiment, the IDs and the IP addresses can be allocated to the code readers 1 via the dedicated control communication line 96, and the code readers 1 can be controlled only by the dedicated control communication. For example, after the installation and wiring of the code readers 1 are completed, the IDs can be allocated from the controller 100 as the bus master to the code readers 1 as the bus slaves via the dedicated control communication line 96, and after the dedicated control communication line 96 becomes communicable, the IP addresses can be allocated to the code readers 1 or the setting information of the code readers 1 can be communicated via the dedicated control communication line 96 as necessary.

The controller 100 and each code reader 1 are synchronized by a dedicated control system using the dedicated control communication line 96. The controller 100 generates a reading start trigger signal and transmits the generated reading start trigger signal to each code reader 1. The reading start trigger signal can vary depending on the type of the code reader 1, and may be, for example, an edge trigger or a level trigger. The edge trigger is a trigger in units of capturing, and a trigger instruction can include a target ID, a capturing time, control parameters, and the like. The code reader 1 executes decoding on only one workpiece W in one capturing. On the other hand, the level trigger is a trigger of start or stop of capturing, and a capturing timing is executed by the code reader 1.

When the reading start trigger signal generated by the controller 100 is received, each code reader 1 generates an illumination timing of each code reader according to a synchronization-ensured time of each code reader. In other words, the controller 100 controls ON and OFF of the illumination of each code reader 1.

Each code reader 1 performs capturing according to an illumination control timing. In Operation Example 1 illustrated in FIG. 2, a capturing cycle of the code readers 1A and 1B other than the bottom-surface reading code reader is a cycle dependent on a decoding time of the decoding unit 44, but in the case of the bottom-surface reading code reader 1C, capturing is performed at a constant cycle.

A specific configuration of the controller 100 will be described with reference to FIG. 9. The controller 100 includes an acquisition unit 101, a recognition unit 102, an acceptance unit 103, a processing determination unit 104, a communication unit 105, an input and output interface 106, a control unit 107, a display processing unit 108, and an output unit 109. The input and output interface 106 is a unit to which the encoder 91, the workpiece sensor 92, the data communication device 93, the setting device 300, the code reader 1, the dimension measurement unit 90, the external controlled device, the collection and analysis device 200, and the like are connected. The input and output interface 106 is connected to the communication unit 105.

The acquisition unit 101 is a unit that acquires a detection signal of the workpiece W by the workpiece sensor 92, conveyor information including a conveyance speed and a conveyor width of the conveyance device B, and installation information indicating a position and a posture of each code reader 1 in the conveyor coordinate system of the conveyance device B. The conveyance speed of the conveyance device B may be acquired based on an output signal of the encoder 91, may be acquired from a movement distance for a predetermined time by using a plurality of workpiece sensors, or may be acquired from a conveyance speed of the conveyance device B set by the user. Note that, even in a case where the encoder 91 calculates a conveyance distance of the workpiece based on the number of pulses for an elapsed time from the detection of the workpiece W to the capturing and the movement distance per unit pulse, it can be considered that the conveyance speed is substantially or indirectly acquired and the conveyance distance is obtained based on the elapsed time and the conveyance speed.

The recognition unit 102 is a unit that recognizes a conveyance state of the workpiece W on the conveyance device B based on the detection signal and the conveyance speed acquired by the acquisition unit 101. The conveyance state includes, for example, a conveyance speed and a position (that is, the position of the workpiece W in the conveyor coordinate system) of the workpiece W on the conveyance device B. The recognition unit 102 can further recognize the conveyance state including the dimensions (width, height, and depth) of the workpiece W and the position and the posture of the workpiece W in the conveyor coordinate system by using the information obtained from the dimension measurement unit 90.

The acceptance unit 103 is a unit that is configured to be able to accept, from the user, a combination of the code readers 1 in which interference of illuminations is desired to be prevented among the plurality of code readers 1 connected to the controller 100. For example, in Operation Example 1 illustrated in FIG. 2, when the illumination of the upstream-side oblique reading code reader 1A and the illumination of the downstream-side oblique reading code reader 1B are simultaneously turned on, the illuminations interfere with each other, and there is a concern that a desired code image cannot be acquired. In a case where it is desired to prevent such interference of the illuminations, the code reader 1A and the code reader 1B are the combination of the code readers 1 in which the interference of the illuminations is desired to be prevented. When the user designates the code reader 1A and the code reader 1B, this combination is accepted by the acceptance unit 103.

The processing determination unit 104 acquires the conveyance state of the workpiece W recognized by the recognition unit 102 and the installation information of each code reader 1 acquired by the acquisition unit 101. The processing determination unit 104 determines a control parameter corresponding to a predetermined conveyance position of the workpiece W on the conveyance device B for each code reader 1 based on the conveyance state of the workpiece W and the installation information of each code reader 1. The processing determination unit 104 can estimate a current position of the workpiece W based on the output signal of the encoder 91 and the detection signal of the workpiece sensor 92. The processing determination unit 104 determines a control parameter in advance before the workpiece W reaches a predetermined conveyance position on the conveyance device B. That is, since which type of workpiece W is currently positioned and where the workpiece W is currently positioned can be acquired as the conveyance state of the workpiece W, it is possible to update and prepare an optimum control parameter for each code reader 1 in advance. Then, when each code reader 1 becomes ready to capture an image, each code reader 1 executes illumination and capturing control by using a latest control parameter at this point in time. The code reader 1 is not limited to the configuration including one capturing unit 3 illustrated in FIG. 5, and may have a configuration including the plurality of capturing units 3 in a housing of the code reader 1. In addition, the code reader 1 is not limited to the configuration including both the capturing unit 3 and the decoding unit 44 inside the housing, and the decoding unit 44 may be provided as a separate device. In the case of these configurations, the processing determination unit 104 determines a control parameter corresponding to a predetermined conveyance position of the workpiece W on the conveyance device B for each capturing unit 3 based on the conveyance state of the workpiece W and the installation information of each capturing unit 3.

The control parameter determined by the processing determination unit 104 includes, for example, an exposure time of the capturing unit 3, a gain, a type of a decoding target code, a reading result output timeout, a capturing range (capturing range of the image sensor 31b), a processing parameter by the preprocessing circuit 32, and the like. The exposure time can be determined according to, for example, the conveyance speed of the conveyance device B acquired based on the output signal of the encoder 91. For example, the exposure time can be shortened as the conveyance speed is faster. The processing determination unit 104 automatically optimizes the exposure time, and thus, the brightness of the image generated by the capturing unit 3 becomes brightness suitable for the decoding processing. In addition, the gain is a gain of the capturing unit 3, and is automatically set to an optimum value by the processing determination unit 104 based on the position of the workpiece W on the conveyance device B and the installation information of the code reader 1. The gain is optimized, and thus, the brightness of the image generated by the capturing unit 3 becomes brightness suitable for the decoding processing.

The processing determination unit 104 is configured to be able to determine, as the control parameter, a code to be read based on the conveyance state of the workpiece W and the installation information of each code reader 1 for each capturing cycle. A type of the decoding target code is a type of a code to be decoded by the decoding unit 44, and a plurality of types of codes can be designated. For example, in a case where a code that does not need to be read is excluded or a code to be read is switched for each capturing based on a reading result of another code reader 1 installed on the upstream side, the processing determination unit 104 determines the type of the decoding target code as the control parameter. In addition, the control parameter can also be determined such that a first code reader 1 reads codes of a first type on the upstream side in the conveyance direction and a second code reader 1 reads codes of a second type on the downstream side.

The processing determination unit 104 can also determine, as the control parameter, the number of digits of the code, a data format, detailed settings for each code type, and the like. In addition, the processing determination unit 104 can also determine, as the control parameter, an upper limit of the number of codes to be searched for in one capturing. In addition, the processing determination unit 104 can also determine, as the control parameter, a capturing prohibition flag. For example, in a case where a decoding processing load of the code reader 1 is high and calculation resources are insufficient, the control parameter is set so as not to temporarily perform capturing. As a result, a load on the code reader 1 can be reduced.

The processing determination unit 104 is configured to be able to determine, as the control parameter, a time limit of the decoding processing (reading result output timeout) based on the conveyance state of the workpiece W and the installation information of each code reader 1 for each capturing cycle. In the case of obfuscated codes, the decoding processing may take a long time, but it is necessary to output the decoding result before the workpiece W on the conveyance device B reaches the output point, and the processing determination unit 104 determines, as the time limit of the decoding processing, a time immediately before the workpiece W on the conveyance device B reaches the output point from the start of decoding.

The control parameter can be changed in units of capturing. The processing parameter by the preprocessing circuit 32 includes parameters for luminance conversion, heat map, and the like. The parameters for the luminance conversion include, for example, parameters related to processing after capturing, such as HDR. The parameters for the heat map are parameters related to the heat map image generation described above.

In addition, the processing determination unit 104 can also determine, as the control parameter, whether or not to output the captured image based on the conveyance speed of the workpiece W for each capturing cycle. That is, the control parameter can include a control flag of the image output to the collection and analysis device 200. When all captured images are set to be output to the collection and analysis device 200, a load of a network band for image output increases. However, the processing determination unit 104 determines a control flag so as to output only some images, and thus, the load of the network band for image output is reduced. For example, the control flag can be used in a case where the image is appropriately thinned such that the entire view of the workpiece W can be grasped. The control flag can be determined based on the output signal of the encoder 91.

The processing determination unit 104 determines the capturing cycle for each code reader 1 based on the conveyance state and the installation information of each code reader 1. In a case where the plurality of code readers 1 are connected, the processing determination unit 104 generates a reference signal that defines a basic cycle common to the code readers 1, and determines the capturing cycle and an illumination cycle for each code reader 1 based on the basic cycle. The basic cycle is a cycle serving as a reference of a turned-on timing of the illumination, and it is possible to prevent interference of a plurality of illuminations by controlling illumination and capturing in accordance with the basic cycle.

The capturing cycle and the illumination cycle are constituted by one or a plurality of basic cycles. The illumination cycle is a cycle in which the illumination unit 2 performs illumination, and is a cycle set by a natural number multiple of the basic cycle. The capturing cycle is a cycle in which the capturing unit 3 executes capturing, and is a cycle set at a natural number multiple of the illumination cycle.

In addition, the processing determination unit 104 determines offset amounts by which start timings of the capturing cycle and the illumination cycle are offset from the reference signal for each code reader 1 based on the conveyance state of the workpiece W by the conveyance device B and the installation information of each code reader 1. The offset amount is set, for example, to delay a start timing of the illumination, and is used to prevent the interference of the plurality of illuminations.

In addition, in a case where the acceptance unit 103 accepts the combination of the code readers 1 in which the interference of the illuminations is desired to be prevented from the user, the processing determination unit 104 generates a plurality of groups for each combination accepted by the acceptance unit 103, and determines the offset amounts of the start timings of the capturing cycle and the illumination cycle from the reference signal for each group.

While there is the combination of the code readers 1 in which the interference of the illuminations is desired to be prevented, it may be desired to synchronize the illuminations of the plurality of code readers 1. For example, as described above, in the case of the configuration including the plurality of capturing units 3 that read the common gap of the conveyance device B from below the conveyance surface of the conveyance device B and the plurality of illumination units 2 corresponding to the plurality of capturing units 3, a large light amount can be secured by synchronizing the plurality of illumination units 2. For example, the processing determination unit 104 can also determine the control parameter so as to cause the plurality of illumination units 2 to emit illumination light rays at overlapping timings.

The communication unit 105 is a unit that executes communication with the plurality of code readers 1 according to the standard of the dedicated control communication, and transmits the control parameter determined by the processing determination unit 104 to each corresponding code reader 1. For example, after the control parameter corresponding to the code reader 1 is determined, the communication unit 105 transmits the corresponding control parameter to each code reader 1 at a timing at which the workpiece W reaches a predetermined conveyance position. Note that, the timing of the transmission is desirably a moment at which the workpiece W reaches the predetermined conveyance position, but may be immediately before or immediately after the moment at which the workpiece W reaches the predetermined conveyance position within a range in which the control parameter can be effectively used.

When the plurality of code readers 1 are connected, the communication unit 105 transmits the capturing cycle determined by the processing determination unit 104 to each corresponding code reader 1, and transmits the illumination cycle determined by the processing determination unit 104 to each corresponding code reader 1. The preprocessing circuit 32 can execute pre-capturing processing and post-capturing processing according to the control parameter.

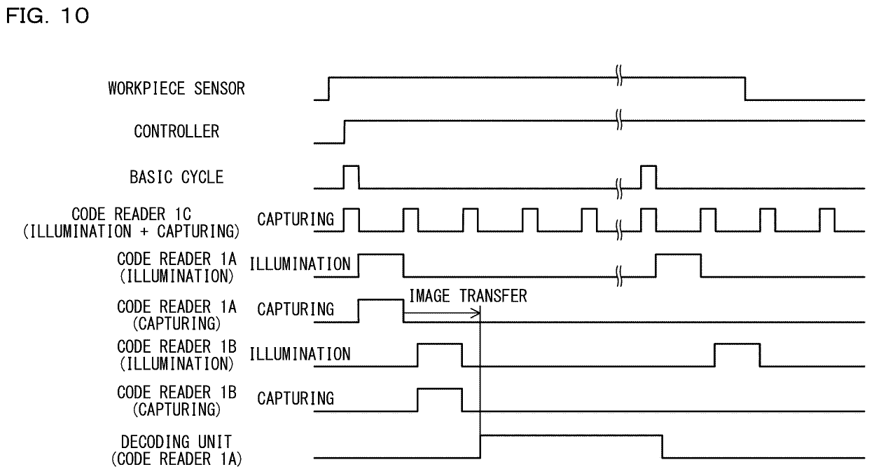

FIG. 10 is a timing chart in a case where the upstream-side oblique reading code reader 1A, the downstream-side oblique reading code reader 1B, and the bottom-surface reading code reader 1C are operated. When a leading edge (front end) of the workpiece W reaches the trigger point, the workpiece sensor 92 outputs the detection signal to be in an ON state, and the ON state is maintained until a trailing edge (rear end) is detected. When the detection signal is received from the workpiece sensor 92, the controller 100 outputs the reading start trigger signal. The upstream-side oblique reading code reader 1A, the downstream-side oblique reading code reader 1B, and the bottom-side reading code reader 1C having received the reading start trigger signal operate according to the reference signal that defines the basic cycle common to the code readers 1A, 1B, and 1C.

The bottom-surface reading code reader 1C having received the reading start trigger signal repeatedly executes capturing by the capturing unit 3 and illumination by the illumination unit 2. The capturing cycle and the illumination cycle at this time may be constituted by one basic cycle or may be constituted by a plurality of basic cycles. The control parameter of the bottom-surface reading code reader 1C is the control parameter determined by the processing determination unit 104.

The start timings of the capturing cycle and the illumination cycle of the upstream-side oblique reading code reader 1A having received the reading start trigger signal are offset from the reference signal, and illumination and capturing are executed according to the capturing cycle and the illumination cycle. The image generated by the capturing unit 3 of the upstream-side oblique reading code reader 1A is transferred to the decoding unit 44. The decoding unit 44 executes the decoding processing on the transferred image.

In addition, the start timings of the capturing cycle and the illumination cycle of the downstream-side oblique reading code reader 1B having received the reading start trigger signal are also offset from the reference signal. The offset amounts of the start timings of the capturing cycle and the illumination cycle of the downstream-side oblique reading code reader 1B are set to be larger than the offset amounts of the start timings of the capturing cycle and the illumination cycle of the upstream oblique reading code reader 1A. The downstream-side oblique reading code reader 1B also executes capturing and illumination according to the capturing cycle and the illumination cycle. The control parameters of the upstream-side oblique reading code reader 1A and the downstream-side oblique reading code reader 1B are also the control parameters determined by the processing determination unit 104. The capturing order of the upstream-side oblique reading code reader 1A, the downstream-side oblique reading code reader 1B, and the bottom-surface reading code reader 1C can be voluntarily set.

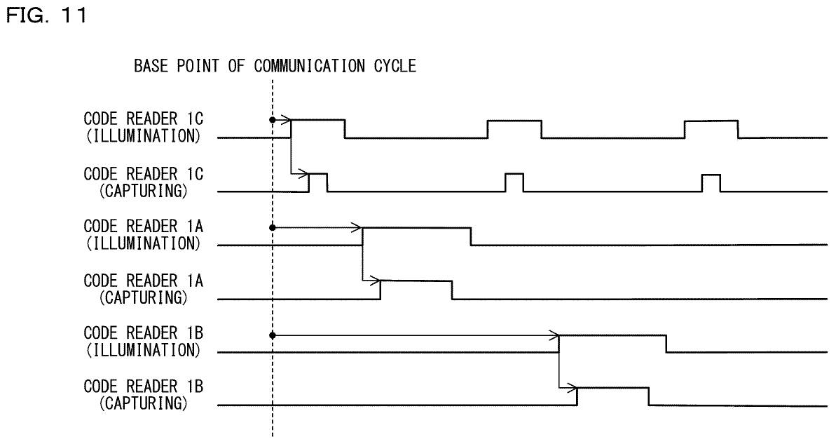

FIG. 11 is a diagram for describing details of the timing chart illustrated in FIG. 10. As illustrated in FIG. 11, synchronization control of the upstream-side oblique reading code reader 1A, the downstream-side oblique reading code reader 1B, and the bottom-surface reading code reader 1C is executed based on a base point of a communication cycle of the dedicated control communication. The illumination timing of the illumination unit 2 and the capturing timing of the capturing unit 3 are set such that capturing is executed between an illumination start timing and an illumination end timing of the bottom-surface reading code reader 1C. Similarly, the illumination timing of the illumination unit 2 and the capturing timing of the capturing unit 3 are set such that capturing is executed between an illumination start timing and an illumination end timing of each of the downstream-side oblique reading code reader 1B and the bottom-surface reading code reader 1C.

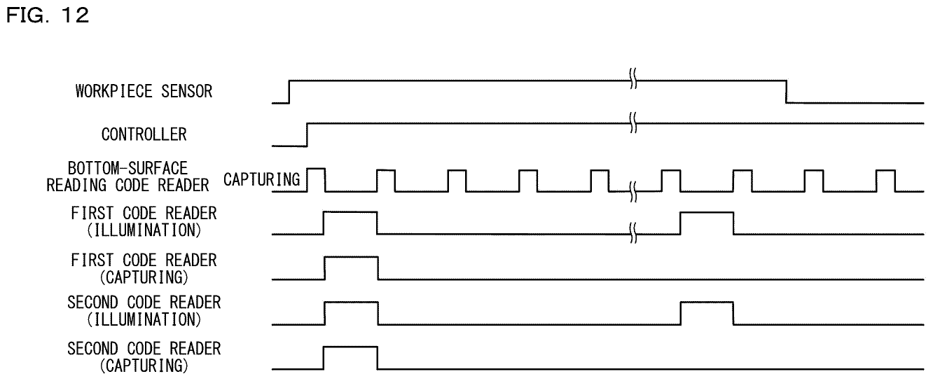

FIG. 12 is a timing chart in a case where illumination units 2 of a first code reader and a second code reader are simultaneously turned on. In the example illustrated in this drawing, the first code reader and the second code reader are installed so as to capture the same surface of the workpiece W. The first code reader and the second code reader having received the reading start trigger signal execute illumination and capturing at a timing offset from the capturing timing of the bottom-surface reading code reader 1C. At this time, since the illumination of the first code reader and the illumination of the second code reader are simultaneously executed, the workpiece W is illuminated brightly, and the luminance of the image generated by the capturing unit 3 can be increased.

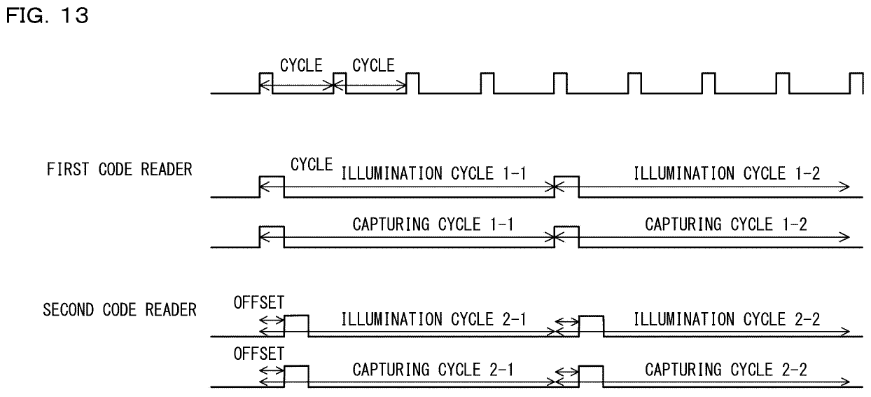

FIG. 13 is a timing chart in a case where the illumination cycle and the capturing cycle are common in all the code readers (illustrated as the first code reader and the second code reader in the drawing). Illumination cycles 1-1 and 1-2 of the first code reader are the same as illumination cycles 2-1 and 2-2 of the second code reader. In addition, capturing cycles 1-1 and 1-2 of the first code reader are the same as capturing cycles 2-1 and 2-2 of the second code reader.

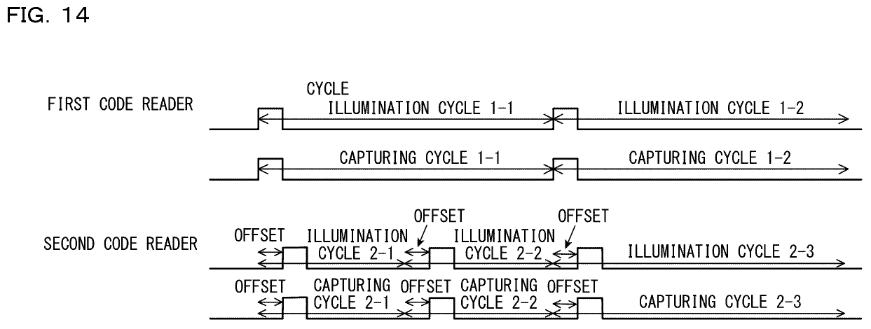

FIG. 14 is a timing chart in a case where the illumination cycle and the capturing cycle are different for each code reader, but are common in units of code readers. That is, an illumination cycle 1-1 and an illumination cycle 1-2 of the first code reader are the same, and a capturing cycle 1-1 and a capturing cycle 1-2 of the first code reader are the same. On the other hand, an illumination cycle 2-1 of the second code reader is different from the illumination cycle 1-1 of the first code reader, and a capturing cycle 2-1 of the second code reader is different from the capturing cycle 1-1 of the first code reader. In addition, illumination cycles 2-1 and 2-2 of the second code reader are the same, and capturing cycles 2-1 and 2-2 of the second code reader are the same. The illumination cycle and the capturing cycle can be changed in the middle.

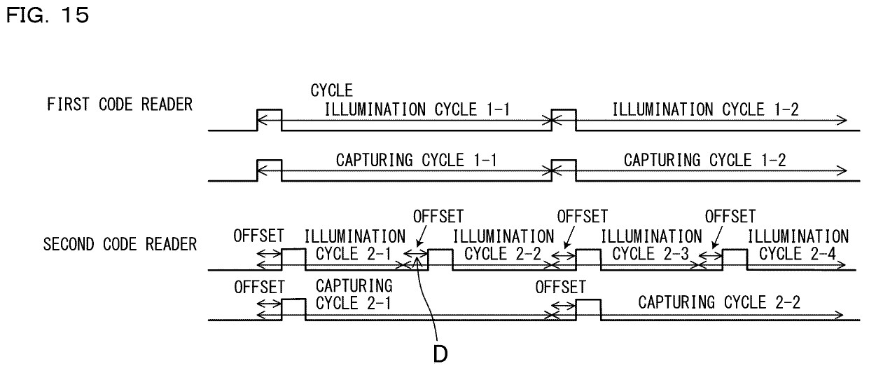

FIG. 15 is a timing chart in a case where the illumination cycle and the capturing cycle are different for each code reader in units of code readers. That is, an illumination cycle 1-1 and an illumination cycle 1-2 of the first code reader are the same, and a capturing cycle 1-1 and a capturing cycle 1-2 of the first code reader are the same. On the other hand, an illumination cycle 2-1 of the second code reader is different from the illumination cycle 1-1 of the first code reader, and a capturing cycle 2-1 of the second code reader is different from the capturing cycle 1-1 of the first code reader. In addition, illumination cycles 2-1 and 2-2 of the second code reader are different from each other, and capturing cycles 2-1 and 2-2 of the second code reader are also different from each other. Since a timing indicated by an arrow D in FIG. 15 is a timing at which the capturing unit 3 is not exposed, the illumination cycle may not be offset.

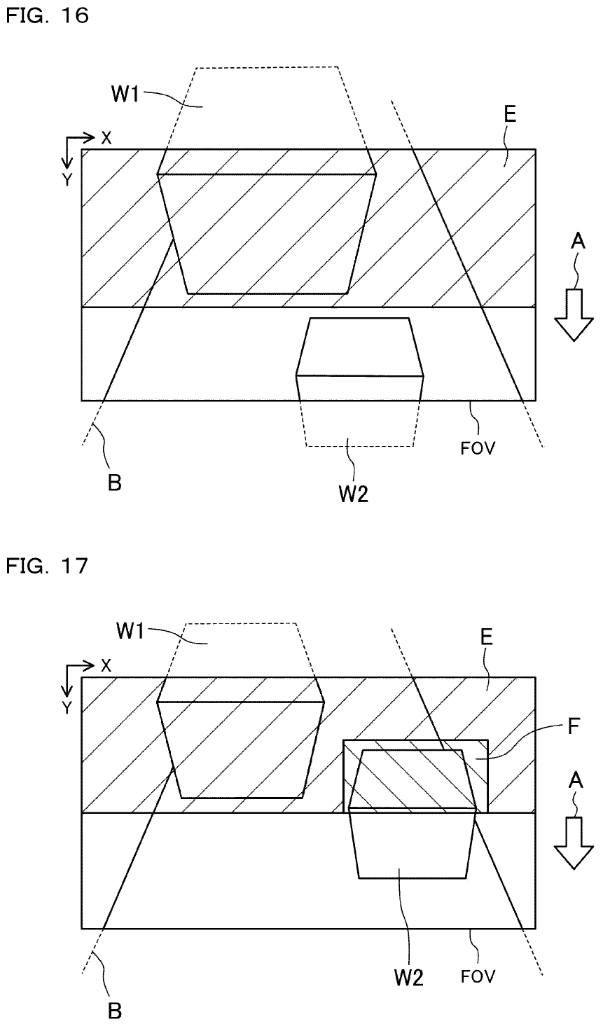

For example, in a distribution industry, while accurate tracking (association between the workpiece W and the read code) is required, since the amount of the workpiece W (package) to be handled tends to increase, it is further required to shorten a distance between the workpieces W being conveyed in order to improve efficiency. Here, since the conveyance device B sequentially conveys the plurality of workpieces W, as illustrated in FIG. 16, a plurality of workpieces W1 and W2 may approach in the conveyance direction (indicated by an arrow A) of the conveyance device B. That is, in a situation where a reading target workpiece W1 approaches a preceding workpiece W2 positioned on the downstream side in the conveyance direction and the capturing unit 3 simultaneously captures the reading target workpiece W1 and the preceding workpiece W2, it is difficult for the code reader 1 side to discriminate whether the read code is given to the reading target workpiece W1 or the preceding workpiece W2, and there is a possibility that the read code is incorrectly associated with the workpiece.

In order to suppress such erroneous association, in the present embodiment, a capturing region by the capturing unit 3 is set to a narrow region where only the reading target workpiece W1 can be captured as indicated by reference numeral E. Specifically, the processing determination unit 104 determines, as the control parameter, a reading region based on the conveyance state and the installation information of each code reader 1 for each capturing cycle. When the reading region is determined, the position of the code reader 1 is specified by, for example, the installation information of the code reader 1. In addition, a relative positional relationship of the reading target workpiece W1 with respect to the code reader 1 can be specified based on the detection signal of the workpiece sensor 92 and the output signal of the encoder 91. Then, the processing determination unit 104 offsets the capturing region of the capturing unit 3 in the Y direction such that only the reading target workpiece W1 is included in the capturing region E.

Specifically, the processing determination unit 104 generates a control parameter for offsetting the capturing region of the capturing unit 3 in the Y direction (corresponding to the V direction of the UV coordinate system). In addition, since the relative positional relationship of the reading target workpiece W1 with respect to the code reader 1 can be specified as described above, a size of the capturing region E of the capturing unit 3 can be designated by the processing determination unit 104 based on this positional relationship. As a result, since the code of the preceding workpiece W2 is not captured, the code of the preceding workpiece W2 is not decoded, and the association of the decoding result of the preceding workpiece W2 with the reading target workpiece W1 can be avoided. The processing determination unit 104 also generates, as the control parameter, information regarding the size of the capturing region E of the capturing unit 3.

FIG. 17 illustrates a case where the plurality of workpieces W1 and W2 approach in the conveyance direction (indicated by an arrow A) of the conveyance device B, the reading target workpiece W1 is positioned on one side in the width direction of the conveyance device B, and the preceding workpiece W2 is positioned on the other side in the width direction of the conveyance device B. In this case, even in the narrow capturing region E illustrated in FIG. 16, at least a part of the preceding workpiece W2 is included in the capturing region E, and the read code and the workpiece may be erroneously associated with each other. On the other hand, the processing determination unit 104 determines, as the control parameter, a mask region F where decoding processing is not executed based on the conveyance state, the workpiece information, and the installation information of each code reader 1 for each capturing cycle. Information regarding dimensions of the reading target workpiece W1 as the workpiece information can be acquired by the dimension measurement unit 90. A position, a size, and a shape of the mask region F in the capturing region E can be determined by using the conveyance state of the reading target workpiece W1 based on the detection signal of the workpiece sensor 92 and the output signal of the encoder 91, the workpiece information of the reading target workpiece W1, and the installation information of each code reader 1. The processing determination unit 104 generates the control parameter such that the decoding unit 44 does not execute the decoding processing even though the determined mask region F is set to a non-target range of the code search or there is a code as a result of the code search. Therefore, the association of the decoding result of the preceding workpiece W2 with the reading target workpiece W1 can be avoided.

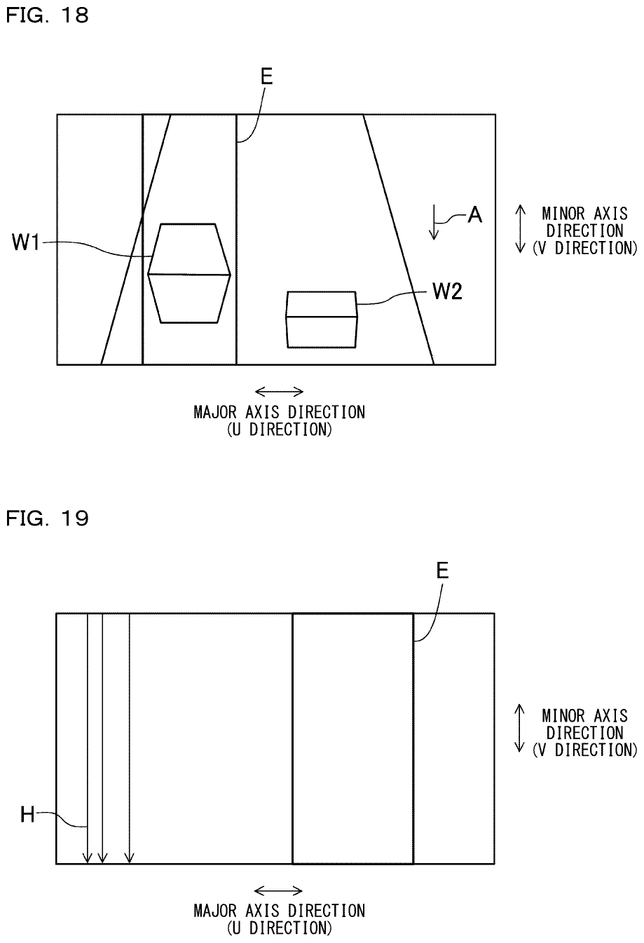

FIG. 18 illustrates an example of a case where a custom sensor in which the number of pixels in the column direction is larger than the number of pixels in the row direction is used as the image sensor 31b. In a case where the plurality of workpieces W1 and W2 approach in the conveyance direction (indicated by an arrow A) of the conveyance device B, the reading target workpiece W1 is positioned on one side in the width direction of the conveyance device B, and the preceding workpiece W2 is positioned on the other side in the width direction of the conveyance device B, it is also possible to cope with the case using the custom sensor without setting the mask region F illustrated in FIG. 17. In the present embodiment, the processing determination unit 104 determines, as the control parameter, a region where only pixels arrayed in some rows of the image sensor 31b are partially read based on the conveyance state of the workpiece W and the installation information of each code reader 1 for each capturing cycle.

That is, the capturing region E corresponding to a capturing field of view of the image sensor 31b is set to be a long field of view not in a major axis direction but in a minor axis direction of the image sensor 31b, and thus, it is possible to prevent the preceding workpiece W2 from being included in the capturing region E. Since a reading direction of a general image sensor is a direction along the major axis of the image sensor, it is not possible to read the capturing region E long in the minor axis direction as illustrated in FIG. 18. However, in the present embodiment, as the custom sensor, a sensor capable of reading in the minor axis direction of the image sensor as indicated by an arrow H in FIG. 19 is used as the image sensor 31b. As a result, the reading of the capturing region E long in the minor axis direction of the image sensor is speeded up. A width of the capturing region E (a length in the major axis direction of the image sensor) is determined by the processing determination unit 104 so as to correspond to the width of the workpiece W.

### (Setting Assistance Function)

The code reader system S has a setting assistance function for assisting setting of the code reader 1. The code reader system S can also be referred to as an apparatus having a setting assistance function, that is, a setting assistance apparatus. In the case of the setting assistance apparatus, since the decoding processing may be executed by an external device, the decoding unit 44 may not be provided.

Hereinafter, the setting assistance function will be described in detail. First, as a premise, the code reader system S has a tracking function of associating the workpiece W with the decoding result of the code attached to the workpiece W. Since it is necessary to accurately associate the workpiece W with the decoding result, in order to improve the accuracy of tracking, calibration for associating the coordinate system (conveyor coordinate system) of the conveyance device B with a capturing coordinate system of the code reader 1 is performed. The code reader system S has a calibration function capable of easily performing the calibration.

The coordinate system of the conveyance device B can be defined as an XYZ coordinate system as illustrated in FIGS. 3, 4A, and 4B. A unit of the coordinate system of the conveyance device B is mm. The capturing coordinate system of the code reader 1 is also referred to as a camera coordinate system, and is a coordinate system obtained by translating the conveyor coordinate system of the conveyance device B to the capturing unit 3 and rotating the conveyor coordinate system, and the Z direction coincides with the optical axis. A unit of the capturing coordinate system of the code reader 1 is mm. The coordinate system (sensor coordinate system) of the image sensor 31b can be defined as the UV coordinate system illustrated in FIGS. 18 and 19. A unit of the coordinate system of the image sensor 31b is a pixel.

The camera information including the number of pixels, the focal length, the sensor size, and the like of the image sensor 31b is known and stored in the storage unit 5 of the code reader 1. The calibration is performed by using the camera information, information input by the user such as the width of the conveyance device B and the installation position and the posture (X coordinate, Y coordinate, Z coordinate, and installation angle) of the code reader 1, and the movement distance (=time information x conveyance speed) of the workpiece W. The movement distance of the workpiece W can also be used, for example, for installation confirmation or the like.

Examples of a precondition when the code reader system S performs calibration are as follows.

1. The conveyance direction of the workpiece W is the Y direction in the coordinate system of the conveyance device B.

2. In a case where the code reader 1 is installed so as to read the upper surface of the workpiece W (in the case of installation on the upper surface), the X direction and the U direction substantially coincide with each other, and the V direction is inclined with respect to the Y direction.

3. In a case where the code reader 1 is installed so as to read the side surface of the workpiece W (in the case of installation on the side surface), the Z direction and the U direction substantially coincide with each other, and the V direction is inclined with respect to the Y direction.

Then, the code reader system S generates an initial calibration model (coordinate transformation coefficient) by using the known camera information and the information input by the user such as the width of the conveyance device B and the installation position and the posture of the code reader 1. Since the position of the workpiece W in the Y direction at a certain time can be calculated based on a speed condition with the detection signal of the workpiece sensor 92 as a reference in the Y-direction, the initial calibration model can be adjusted by using the calculation result. The initial calibration model is adjusted to generate an adjusted calibration model, and thus, the position of the workpiece W on the image can be accurately known.

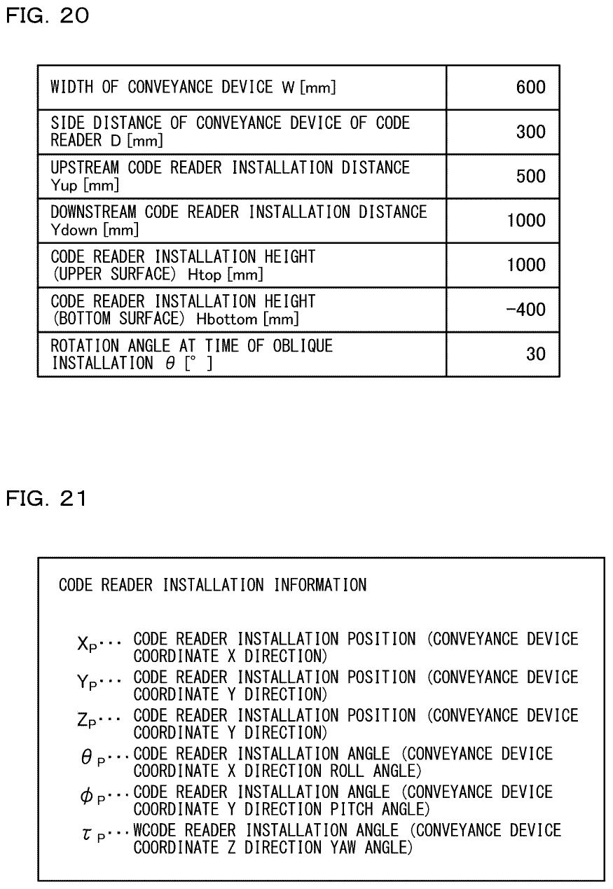

Hereinafter, a calibration procedure will be described. First, the acquisition unit 101 acquires installation information indicating the position and the posture of the code reader 1, that is, the conveyance device B of the capturing unit 3 in the conveyor coordinate system. The installation information includes an X coordinate, a Y coordinate, a Z coordinate, an installation angle, and the like of the code reader 1, and is input by the user operating the setting device 300 or the like after measurement. In addition, the width of the conveyance device B is also input by the user operating the setting device 300 or the like. Examples of input numerical values are illustrated in FIG. 20. In addition, the acquisition unit 101 further acquires the detection signal of the workpiece W by the workpiece sensor 92. In addition, the acquisition unit 101 also acquires the conveyor information including the width and the conveyance speed of the conveyance device B.

As illustrated in FIG. 9, the controller 100 includes the control unit 107, and the control unit 107 defines the coordinate system of the conveyance device B with the position of the workpiece sensor 92 as a reference. For example, an origin of the Y coordinate of the coordinate system of the conveyance device B can be set as the position of the workpiece sensor 92, but the invention is not limited thereto. In addition, the control unit 107 calculates the position of the conveyance device (conveyor position) on the captured image based on the camera information, the conveyor information, and the installation information of the code reader 1.

The control unit 107 calculates the position and the installation angle of each code reader 1 in the coordinate system of the conveyance device B based on the information illustrated in FIG. 20. A calculation example of the position and the installation angle of each code reader 1 is illustrated in FIG. 21. As illustrated in this drawing, the control unit 107 calculates the X, Y, and Z coordinates of the code reader 1 in the coordinate system of the conveyance device B, and a roll angle in the X direction, a pitch angle in the Y direction, and a yaw angle in the Z direction.

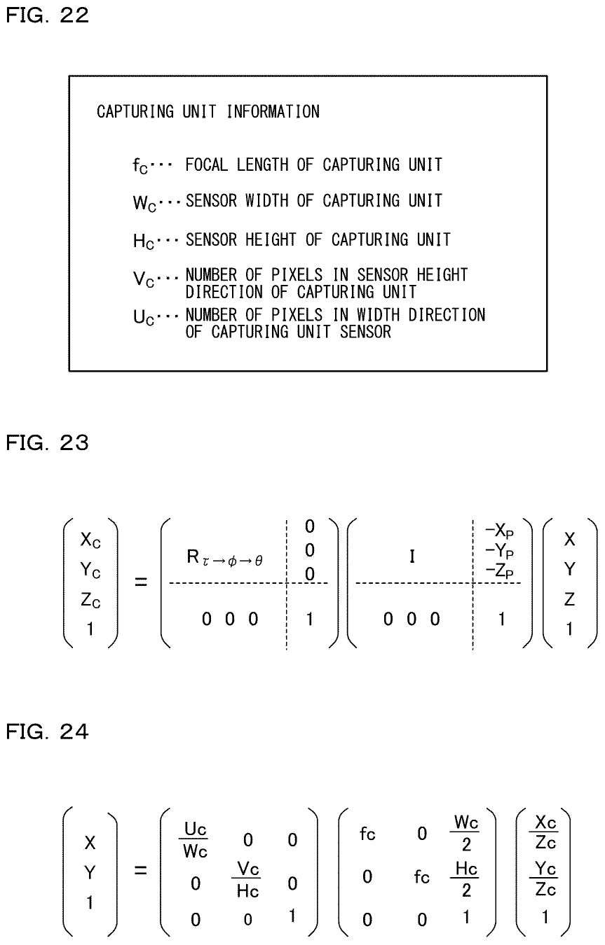

The acquisition unit 101 also acquires the camera information. The camera information acquired by the acquisition unit 101 is illustrated in FIG. 22, and the camera information includes the focal length of the capturing unit 3, the dimension of the width (U direction) of the image sensor 31b, the dimension of the height (V direction) of the image sensor 31b, the number of pixels of the image sensor 31b in the height direction, the number of pixels of the image sensor 31b in the width direction, and the like.

The user can also input the size and the code information of the workpiece W. For example, the control unit 107 calculates an installation candidate position of the capturing unit 3 based on at least one of the size of the workpiece W, the conveyor width, and the code information input from the user. In this case, the acquisition unit 101 acquires, as the installation information, the installation candidate position calculated by the control unit 107.

FIG. 23 is an example of a transformation expression that can be used when the conveyor coordinate system of the conveyance device B is transformed into the capturing coordinate system of the code reader 1. This transformation expression includes a rotation matrix (for example, in the order of the yaw angle, the pitch angle, and the roll angle) for the installation angle of the code reader 1 and a translation matrix for the installation position of the code reader 1, and the control unit 107 can transform the coordinate system of the conveyance device B into the capturing coordinate system of the code reader 1 by using the rotation matrix and the translation matrix.

FIG. 24 is an example of a transformation expression that can be used when the capturing coordinate system of the code reader 1 is transformed into the UV coordinate system (corresponding to the XY coordinate system in FIG. 16) of the image sensor 31b. This transformation expression includes a matrix that transforms mm into a unit pixel, scale transformation of the image sensor 31b onto a plane, and a matrix that moves an origin position to an upper left side of the image sensor 31b. The control unit 107 can transform the capturing coordinate system of the code reader 1 into the UV coordinate system of the image sensor 31b by using these matrices.

As illustrated in FIGS. 23 and 24, the control unit 107 generates a calibration model indicating a correspondence between the conveyor coordinate system of the conveyance device B and the UV coordinate system of the image sensor 31b based on the camera information, the conveyor information, and the installation information of the code reader 1 acquired by the acquisition unit 101.

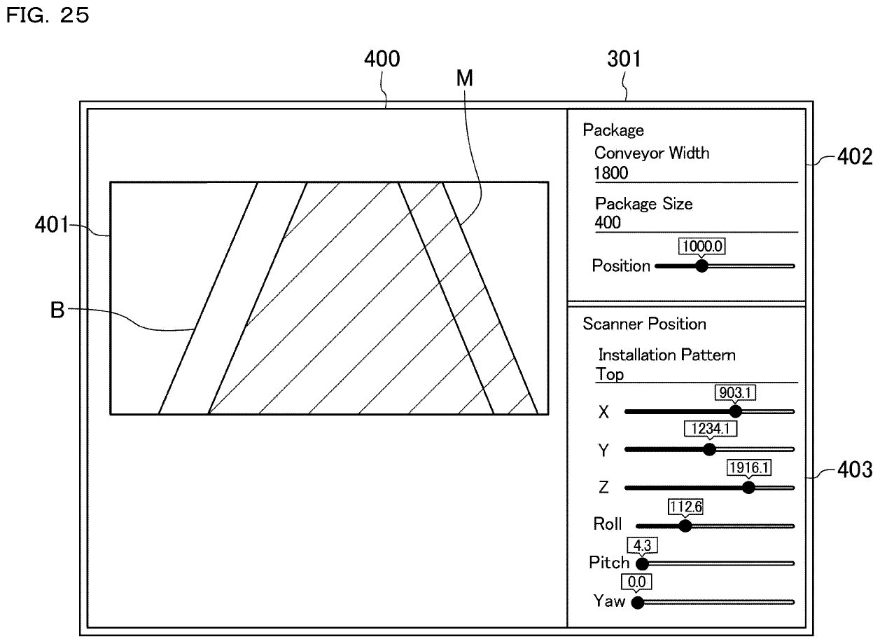

In FIG. 25, an installation confirmation image using the calibration model indicating a correspondence between the coordinate system of the conveyance device B and the UV coordinate system of the image sensor 31b can be displayed on the display unit 301 or the like of the setting device 300. An image display region 401 for displaying the installation confirmation image, a workpiece information display region 402, and a code reader information display region 403 are provided on a user interface screen 400. In this example, a conveyor position M (virtual conveyor position) calculated by the calibration model is displayed, as the captured image, to be superimposed on the image (image having a plurality of horizontal lines) of the conveyance device.

The conveyor position M indicates a region estimated as the conveyance device, and may be displayed in a form in which the entire region is filled, or only a portion corresponding to an edge of the conveyance device may be displayed. Since the conveyor position M indicates the region of the conveyance device, it is possible to indicate the region estimated as the conveyance device to the user by displaying the conveyor position M to be superimposing on the captured image. The image indicating the conveyor position M in the captured image is the installation confirmation image for confirming installation.

Instead of the image of the conveyance device, or in addition to the image of the conveyance device, a line serving as a reference for alignment (alignment reference line) such as a center line of the conveyance device may be displayed. The alignment reference line can also be a part of the installation confirmation image.

In the workpiece information display region 402, the width of the conveyance device B, the dimensions of the workpiece W, and the position of the workpiece W are displayed. In the code reader information display region 403, the installation position, the installation angle, and the like (position parameter) of the code reader 1 calculated based on the installation information are displayed. Note that, since the code reader 1 captures the workpiece W, the code reader 1 can also be referred to as a scanner, and in the example illustrated in FIG. 25, “Scanner Position” is displayed in the code reader information display region 403.

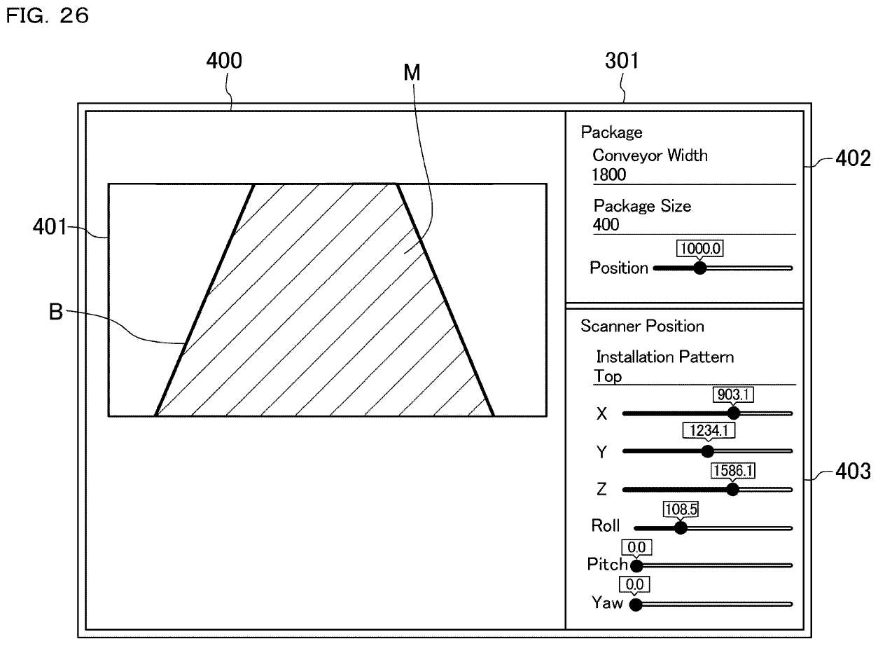

When the position parameter that defines the position of the code reader 1 is changed, as illustrated in FIG. 26, the change of the position parameter is reflected on the display user interface screen 400 to adjust the calibration model, and the conveyor position M calculated by the adjusted calibration model and an actual position of the conveyance device can be made to coincide with each other on the installation confirmation image. At this time, the X coordinate, the Z coordinate, the roll angle in the X direction, the pitch angle in the Y direction, and the yaw angle in the Z direction of the code reader 1 are adjusted.

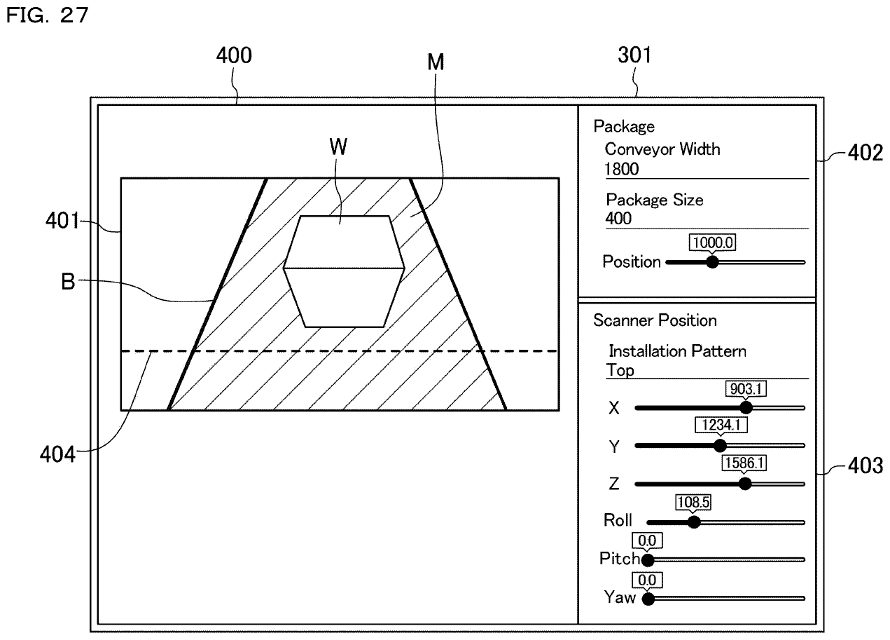

FIG. 27 is an example in which the image of the workpiece W conveyed by the conveyance device B is displayed. The acquisition unit 101 directly or indirectly acquires the conveyance speed of the conveyance device B based on, for example, the output signal of the encoder 91, a set value set by the user, or the like. The control unit 107 causes the capturing unit 3 to capture the workpiece W conveyed on the conveyance device B and generate the captured image. The display processing unit 108 displays, in the image display region 401, the installation confirmation image indicating the characteristic portion (the edge or the like to be described later) of the workpiece W calculated by the adjusted calibration model in the captured image generated by the capturing unit 3.

The control unit 107 calculates the position of the characteristic portion of the workpiece W in the coordinate system of the conveyance device B at a point in time at which the captured image is captured based on the detection signal by the workpiece sensor 92 and the conveyance speed. For example, when the elapsed time from the detection of the workpiece W to the point in time at which the capturing is performed and the conveyance speed are known, it is possible to know how much the workpiece has moved since the detection. Note that, the detection signal includes not only a signal directly transmitted from the workpiece sensor 92 to the controller 100, but also a signal received from the workpiece sensor 92 and transmitted from the PLC to the controller 100 in a case where the workpiece sensor 92 is connected to the controller 100 via the PLC. The characteristic portion of the workpiece W is not particularly limited, but may be, for example, an edge portion of the workpiece W, a code portion of the workpiece W, or the like. Note that, since the edge portion of the workpiece W is easily detected, the accuracy of adjustment is easily improved. A method for calculating the characteristic portion of the workpiece W is not limited to one method, and for example, the control unit 107 can calculate the characteristic portion of the workpiece W in the captured image based on the detection signal of the workpiece sensor 92 and the conveyor information.

Hereinafter, a method for specifying the characteristic portion of the workpiece W will be described with specific examples. The control unit 107 can specify, as the characteristic portion, the edge portion of the workpiece W detected by executing edge detection processing on the captured image. For example, in a case where the workpiece W is positioned on a far side, it is possible to execute super-resolution processing and optimal edge detection processing on the assumption that the workpiece W is positioned on the far side. The code reader 1 installed directly above the workpiece W can determine whether the workpiece W is on a near side or a far side in the Z direction. In addition, the code reader 1 installed on the side of the workpiece W can determine whether the workpiece W is a near side or a far side in the X direction.

In addition, the control unit 107 can also specify, as the characteristic portion, a portion detected by executing code detection processing on the captured image. The code detection processing can be similar to the processing by the code detection unit 43. In addition, the control unit 107 can specify, as the characteristic portion, a portion for which the decoding processing has succeeded by executing the decoding processing on the captured image. The decoding processing can be similar to the processing by the decoding unit 44. That is, for example, coordinates specified by executing image processing such as the edge detection processing, the code detection processing, and the decoding processing on the captured image can be set as coordinates of a position corresponding to the characteristic portion of the workpiece W. The image processing includes object detection processing and the like in addition to the above processing, and may be rule-based detection processing or detection processing using artificial intelligence (AI).

The control unit 107 acquires the position of the characteristic portion of the workpiece W in the coordinate system of the conveyance device B and the position corresponding to the characteristic portion of the workpiece W in the UV coordinate system of the captured image. Then, the control unit 107 further adjusts the parameter of the adjusted calibration model in the conveyance direction based on the position of the characteristic portion of the workpiece W in the coordinate system of the conveyance device B and the position corresponding to the characteristic portion of the workpiece W in the UV coordinate system of the captured image.

That is, the control unit 107 acquires a detection time of the workpiece sensor 92 (time at which the detection signal is output) and the capturing time by the capturing unit 3, and calculates the elapsed time from the detection time to the capturing time. The control unit 107 estimates a leading edge position of the workpiece W based on the calculated elapsed time and the conveyance speed of the workpiece W, and draws the leading edge position as an edge display line 404 on an adjustment image.

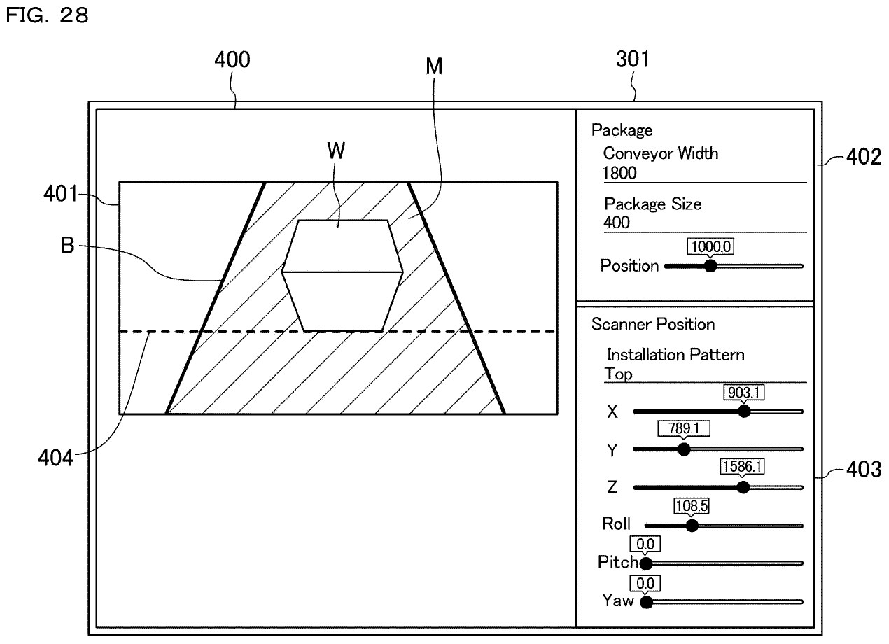

When the position parameter of the code reader 1 is changed to align the edge display line 404 with the corresponding edge portion of the workpiece W, the change in the position parameter is reflected on the display user interface screen 400 as illustrated in FIG. 28. At this time, the Y coordinate of the code reader 1 is adjusted. That is, an operation for aligning the edge display line 404 with the corresponding edge portion of the workpiece W is an operation performed by the user operating the operation unit 302 or the like via the display unit 301, and is an operation for correcting the installation information. When the correction of the installation information is accepted from the user via the display unit 301, the display processing unit 108 changes and displays at least one position of the conveyor position on the installation confirmation image and the characteristic portion of the workpiece W according to the correction. An operation for correcting the installation information may be, for example, an operation by directly inputting a numerical value included in the installation information without using the display unit 301.

Note that, the installation information can also be corrected by directly moving the edge display line 404 in a vertical direction of the display user interface screen 400. As described above, the coordinates of the position corresponding to the characteristic portion of the workpiece W in the UV coordinate system of the captured image can be coordinates designated as the characteristic portion of the workpiece W by the user with respect to the captured image. In addition, the installation confirmation image may indicate at least one of the conveyor position and the characteristic portion of the workpiece W without indicating both the conveyor position and the characteristic portion of the workpiece W.

The control unit 107 can cause the capturing unit 3 to capture the workpiece W conveyed by the conveyance device B multiple times at different timings. In this case, the control unit 107 can adjust the parameter of the calibration model in the conveyance direction based on the position of the characteristic portion of the workpiece W in the coordinate system of the conveyance device B and the position corresponding to the characteristic portion in the UV coordinate system of each captured image for each captured image of a plurality of captured images obtained by capturing the workpiece W conveyed by the conveyance device B multiple times at different timings by the capturing unit 3. That is, since UV coordinates of the edge portion designated by the user and the position detected by the image processing may not necessarily accurately indicate the characteristic portion of the workpiece W, the accuracy can be improved by repeating the parameter adjustment multiple times.

Although FIGS. 25 to 28 illustrate a case where the code reader 1 is installed above the workpiece W, the code reader 1 may be installed on the side of the workpiece Was illustrated in FIGS. 3 and 4A. A case where the code reader 1 is installed on the side of the workpiece W will be described.

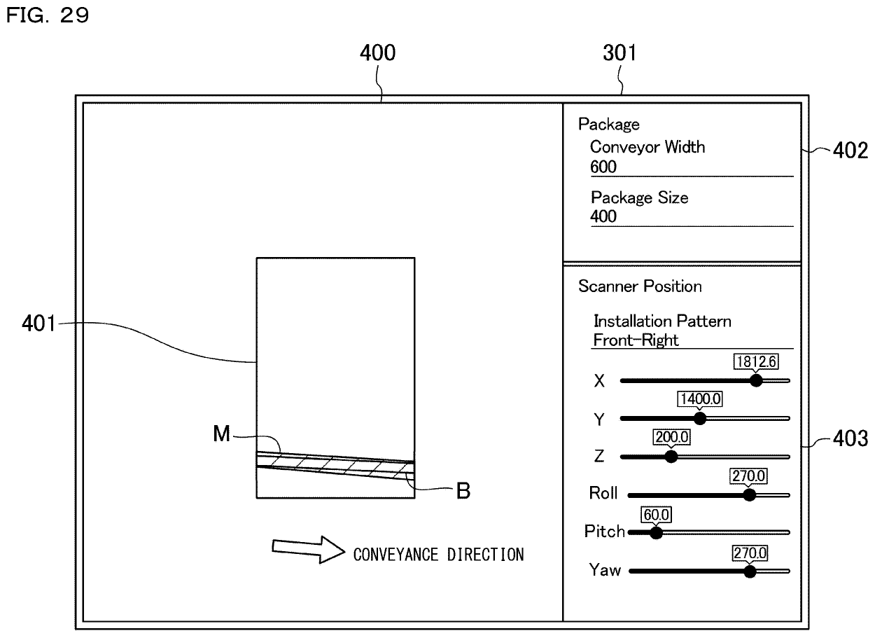

FIG. 29 illustrates the installation confirmation image in a case where the code reader 1 is installed so as to capture the workpiece W from the side on the upstream side of the workpiece W. In this example, the major axis direction of the image sensor 31b is made to coincide with the Z direction in the coordinate system of the conveyance device B. In addition, a case where the workpiece W is directed from the downstream side to the upstream side in the conveyance direction is illustrated. For example, the control unit 107 can acquire the installation angle of the capturing unit 3 in the coordinate system of the conveyance device B and can determine an orientation of the field of view of the capturing unit 3 based on the acquired installation angle. In a case where the image sensor 31b is the custom sensor that can be read in the minor axis direction of the image sensor as illustrated in FIG. 19, the reading direction of the image sensor 31b and the conveyance direction can be made to coincide with each other.

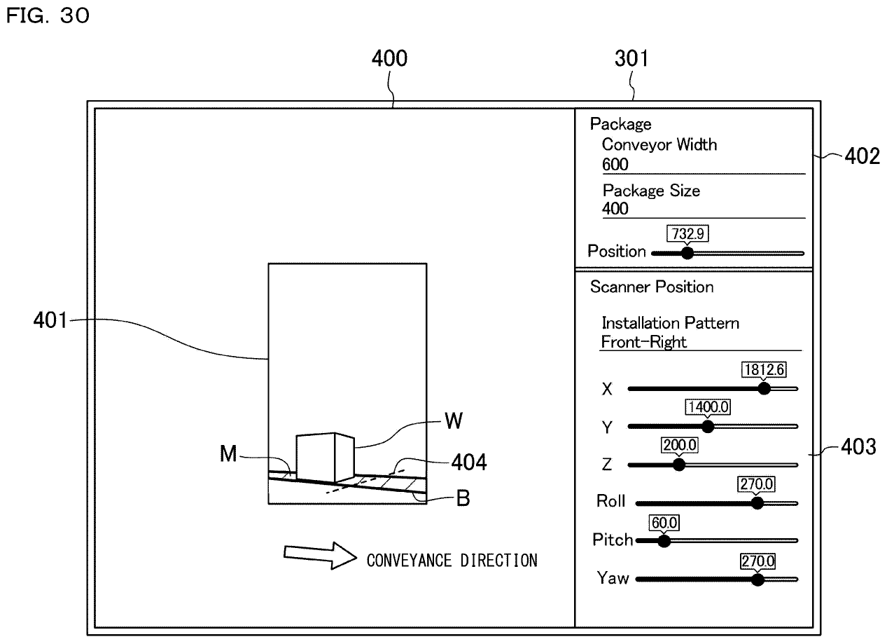

FIG. 30 illustrates an example in which the image obtained by capturing the conveyed workpiece W from the upstream side is displayed, and the installation confirmation image in which the edge display line 404 is drawn on the captured image is displayed in the image display region 401. The control unit 107 acquires the detection signal and the conveyor information of the workpiece sensor 92, and transmits a trigger to the capturing unit 3 such that the characteristic portion of the workpiece W is included in the installation confirmation image based on the acquired detection signal and conveyor information, and controls the capturing unit 3 to generate the captured image.

Specifically, in a case where the field of view of the capturing unit 3 spreads from the upstream side to the downstream side in the conveyance direction, the control unit 107 specifies the leading edge (edge portion at an upstream end in the conveyance direction) of the workpiece W as the characteristic portion of the workpiece W. When the edge display line 404 is aligned with the corresponding edge portion (edge portion at the upstream end in the conveyance direction) of the workpiece W, the Y coordinate of the code reader 1 is adjusted. As described above, in a case where the field of view of the capturing unit 3 is directed from the downstream side to the upstream side of the conveyance device B, the acquisition unit 101 acquires designation from the user by using the leading edge of the workpiece W as the characteristic portion of the workpiece W.

After the parameter of the calibration model is adjusted in this manner, at the time of operation, the control unit 107 determines, as a region where a signal is read from the image sensor 31b, a region where the workpiece W is captured as a first partial region. When the first partial region is determined, a signal of the first partial region is read from the image sensor 31b and can be displayed as illustrated in FIG. 17.

In a case where the field of view of the capturing unit 3 is directed from the downstream side to the upstream side of the conveyance device B, the control unit 107 controls the capturing unit 3 such that the leading edge of the workpiece W is included, as the characteristic portion of the workpiece W, in the installation confirmation image, that is, the leading edge of the workpiece W is included in the region where the signal is read from the image sensor 31b.

In addition, at the time of operation, the control unit 107 can also determine a second partial region where image processing is executed on the image. For example, in a case where mask processing is executed as the image processing, a portion other than the workpiece W in the image is set as the second partial region, and the mask processing is executed on the second partial region. As a result, the region where the decoding processing is not executed can be specified. The second partial region is set as the non-target range of the code search, and the decoding processing is not executed even though there is a code as a result of the code search.

In addition, the super-resolution processing can also be executed as the image processing. In this case, the portion of the workpiece W in the image is set as the second partial region, and the super-resolution processing is executed on the second partial region. As a result, a reading success rate can be improved even for the obfuscated code. As described above, the control unit 107 can recognize the conveyance state of the workpiece W conveyed on the conveyance device B based on, for example, the detection signal of the workpiece sensor 92 and the conveyance speed of the conveyance device B, and can determine at least one of the first partial region where the signal is read from the image sensor 31b and the second partial region where the image processing is executed on the captured image based on the conveyance state of the workpiece W and the adjusted calibration model.

When a target workpiece to be captured and an adjacent workpiece adjacent to the target workpiece are included in a field of view (FOV) of the capturing unit 3, the control unit 107 can also determine at least one of a first partial region that includes the target workpiece but does not include the adjacent workpiece and a second partial region that includes the adjacent workpiece and where the mask processing is executed. That is, as illustrated in FIG. 16, when the target workpiece is the reading target workpiece W1 and the adjacent workpiece is the preceding workpiece W2, a first partial region (the same region as the region E in FIG. 16) that includes the reading target workpiece W1 but does not include the preceding workpiece W2 is determined. In this case, the first partial region is the region where the signal is read from the image sensor 31b. In addition, as illustrated in FIG. 17, the control unit 107 can also determine a second partial region (mask region F in FIG. 17) including the preceding workpiece W2, and in this case, the second partial region is a region where the mask processing is executed.

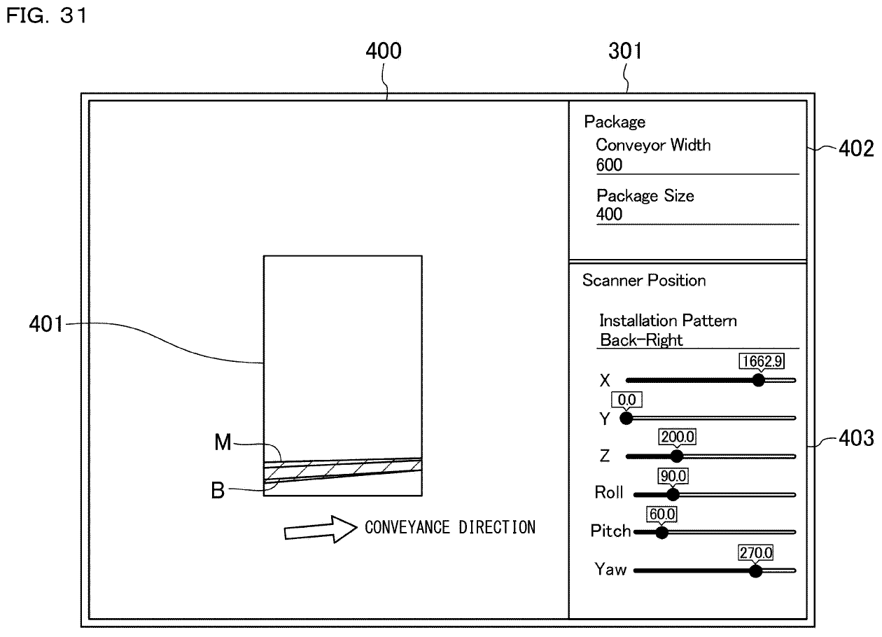

FIG. 31 illustrates the conveyor position M in a case where the code reader 1 is installed so as to capture the workpiece W from the side on the downstream side of the workpiece W. In this example, similarly to the example illustrated in FIG. 29, the major axis direction of the image sensor 31b is made to coincide with the Z direction in the coordinate system of the conveyance device B.

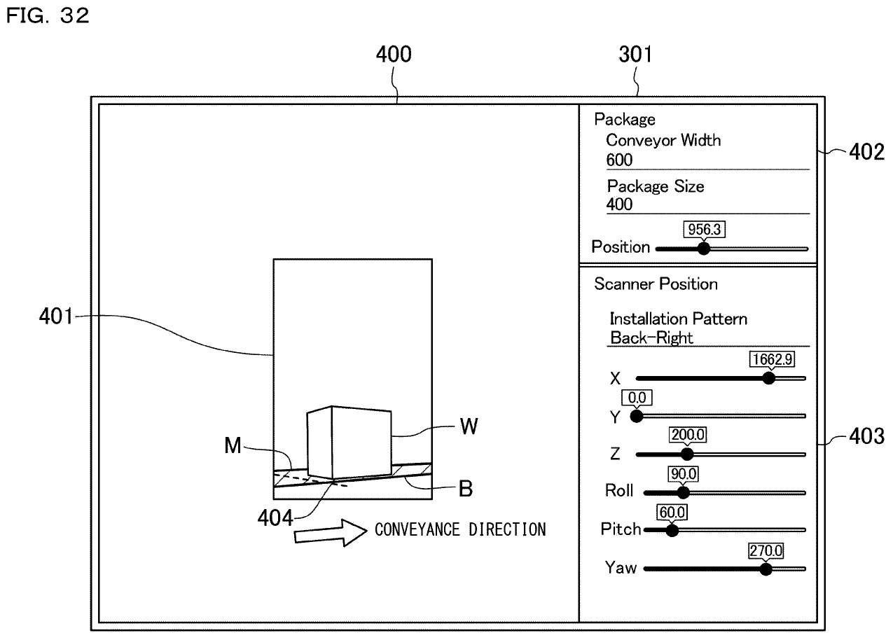

FIG. 32 illustrates an example in which the image obtained by capturing the conveyed workpiece W from the downstream side is displayed, and the edge display line 404 is drawn on the captured image. Specifically, in a case where the field of view of the capturing unit 3 spreads from the downstream side to the upstream side in the conveyance direction, the control unit 107 specifies the trailing edge (edge portion at a downstream end in the conveyance direction) of the workpiece W as the characteristic portion of the workpiece W. When the edge display line 404 is aligned with the corresponding edge portion (edge portion at the downstream end in the conveyance direction) of the workpiece W, the Y coordinate of the code reader 1 is adjusted. As described above, in a case where the field of view of the capturing unit 3 is directed from the upstream side to the downstream side of the conveyance device B, the acquisition unit 101 can acquire designation from the user by using the trailing edge of the workpiece W as the characteristic portion of the workpiece W.

Even in a case where the characteristic portion of the workpiece W is the trailing edge of the workpiece W, the capturing unit 3 is controlled such that the characteristic portion is included in the installation confirmation image, similarly to the case of the leading edge. Specifically, in a case where the field of view of the capturing unit 3 is directed from the upstream side to the downstream side of the conveyance device B, the control unit 107 controls the capturing unit 3 such that the trailing edge of the workpiece W is included in the installation confirmation image as the characteristic portion of the workpiece W.

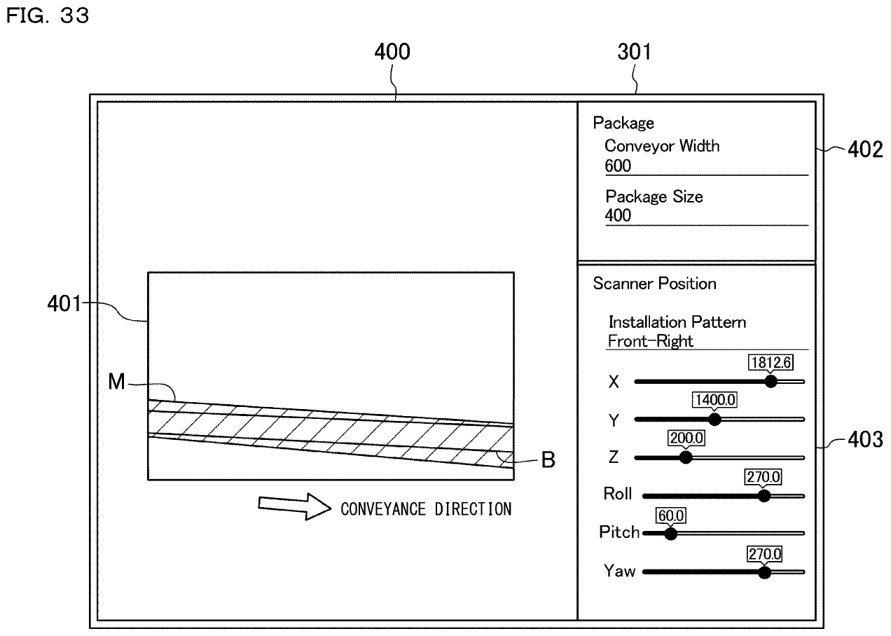

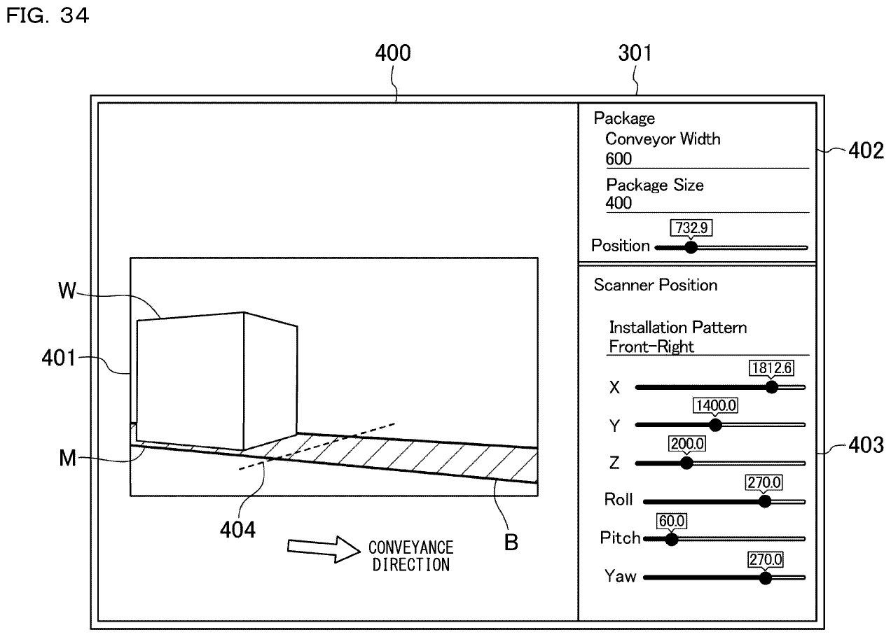

FIG. 33 relates to a modification of the example illustrated in FIG. 29, and in this modification, the minor axis direction of the image sensor 31b is made to coincide with the Z direction in the coordinate system of the conveyance device B. In a case where the image sensor 31b is the custom sensor, the reading direction of the image sensor 31b can be made to coincide with the Z direction. In this modification, since the edge display line 404 is drawn on the captured image as illustrated in FIG. 34, when the edge display line 404 is aligned with the corresponding edge portion of the workpiece W, the Y coordinate of the code reader 1 is also adjusted.

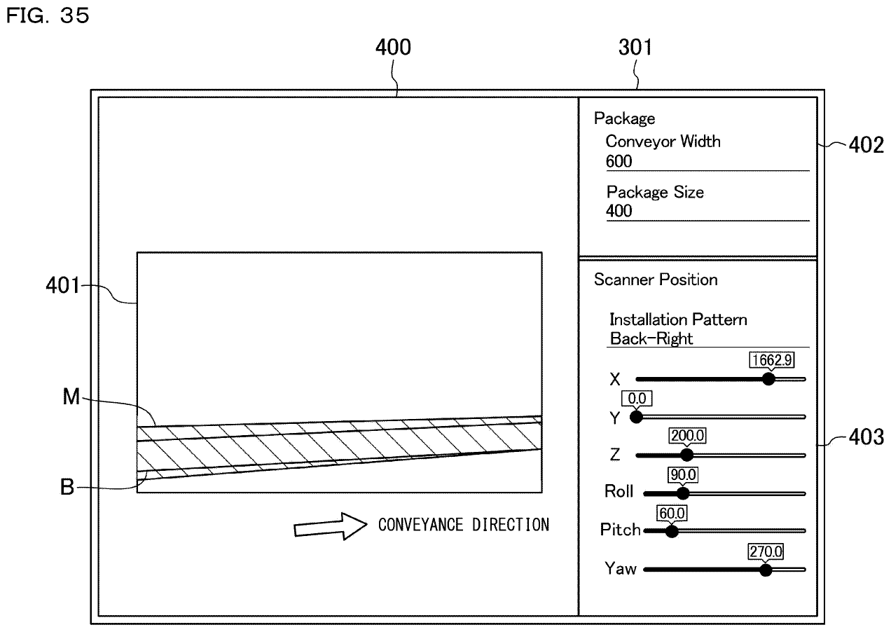

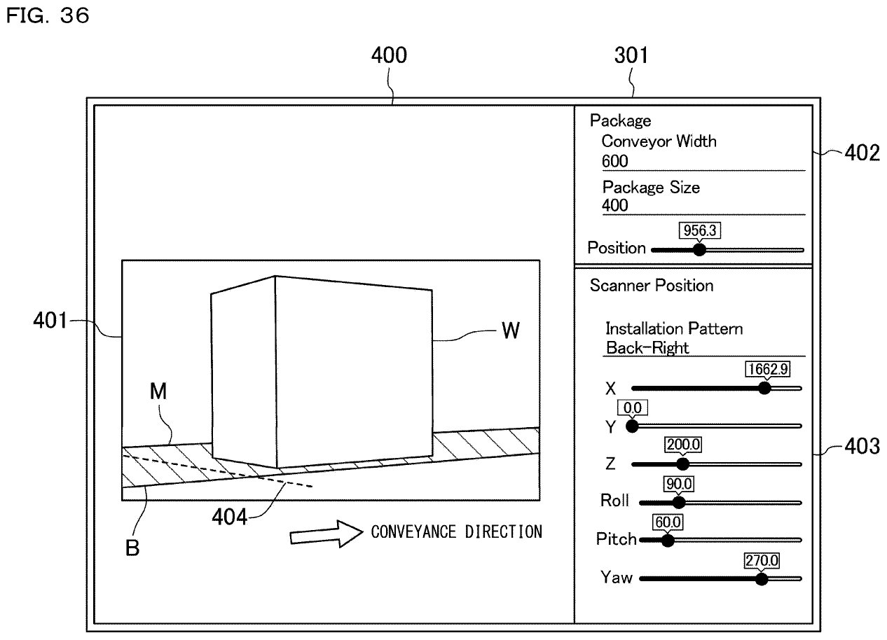

FIG. 35 relates to a modification of the example illustrated in FIG. 31, and in this modification, the minor axis direction of the image sensor 31b is made to coincide with the Z direction in the coordinate system of the conveyance device B. In a case where the image sensor 31b is the custom sensor, the reading direction of the image sensor 31b coincides with the Z direction. In this modification, since the edge display line 404 is drawn on the captured image as illustrated in FIG. 36, when the edge display line 404 is aligned with the corresponding edge portion of the workpiece W, the Y coordinate of the code reader 1 is also adjusted.

Even in a case where the code readers are installed at a plurality of installation positions as illustrated in FIG. 3, according to the above configuration, at the time of calibration, since images illustrated in FIGS. 27, 30, 32, 34, and 36, which are used for adjusting the parameters of the calibration models of the code readers in the conveyance direction, can be collectively acquired only by conveying the workpiece W once by the conveyance device B, a burden at the time of calibration of the user can be reduced.

As illustrated in FIG. 9, the controller 100 includes the output unit 109. The output unit 109 is a unit that outputs an installation confirmation report including the installation confirmation image indicating the conveyor position and the characteristic portion of the workpiece W in the captured image. The installation confirmation report may include any one or more of a code reading test result by the decoding unit 44, an installation date and time, an installation location, installation information, camera information, workpiece information, and the like together with the installation confirmation image. The installation confirmation report may be output in a format of an electronic file (electronic data) or may be output by being printed on a paper medium. The installation confirmation report is created, and thus, the basis of the reading test result can be indicated by the image.

The controller 100 generates an image output parameter and transmits the image output parameter to the code reader 1. When the image output parameter transmitted from the controller 100 is received, the code reader 1 executes image output processing according to the received image output parameter. An output of a setting image and an output of a collection image can be executed by the image output parameter.

The setting image is a test image output to the setting device 300 or the like for user confirmation and used in the code reading test at the time of setting and a captured image used in installation adjustment, and an installation confirmation image is generated based on the captured image.

The collection image is output to the collection and analysis device 200, and is used as an analysis image of an error analysis function to be described later, a learning image, and a user confirmation at the time of error occurrence.

### (Error Analysis Function)

At the time of operation of the code reader system S, the reading of the code may fail. This failure is referred to as an error, and since there are various error causes, it may be difficult for the user to specify the error. On the other hand, the code reader system S of the present embodiment has an error analysis function as a function for estimating the error cause based on an image related to a workpiece ID given to each workpiece W and facilitating the user to solve the error. In the error analysis function, it is possible to specify when the workpiece W on the conveyance device B is positioned and where the workpiece is positioned on the conveyance device B to perform error analysis in units of workpieces W, and it is possible to easily specify which workpiece W cannot be read and the error cause. The error analysis function can be realized by the collection and analysis device 200 which is the personal computer described above. Examples of the configuration of the personal computer include a microcomputer including a processor (including a CPU and a GPU), a ROM, a RAM, and the like.

When the detection signal is acquired from the workpiece sensor 92, the control unit 107 of the controller 100 generates a workpiece ID for each workpiece W based on the acquired detection signal. The workpiece ID is identification information for identifying the workpiece W, and is different for each workpiece W. The workpiece ID generated by the control unit 107 is associated with the image generated by the capturing unit 3 and is also associated with the result of the decoding processing by the decoding unit 44.

As illustrated in FIGS. 3, 4A, and 4B, in Operation Examples 1 and 2 in which the plurality of code readers 1 capture the common workpiece W, the plurality of images are generated by the capturing units 3 of the plurality of code readers 1. An image storage unit 201 (for example, an SSD or an HDD) included in the collection and analysis device 200 stores a plurality of images (collection images) generated by the capturing units 3 of the plurality of code readers 1 in association with corresponding workpiece IDs. In addition, as a result of the decoding processing of the code of each image by the decoding unit 44, there are a case where reading has succeeded and a case where reading has failed, and the workpiece ID is associated with each of the image of the workpiece W for which reading has succeeded and the image of the workpiece W for which reading has failed.

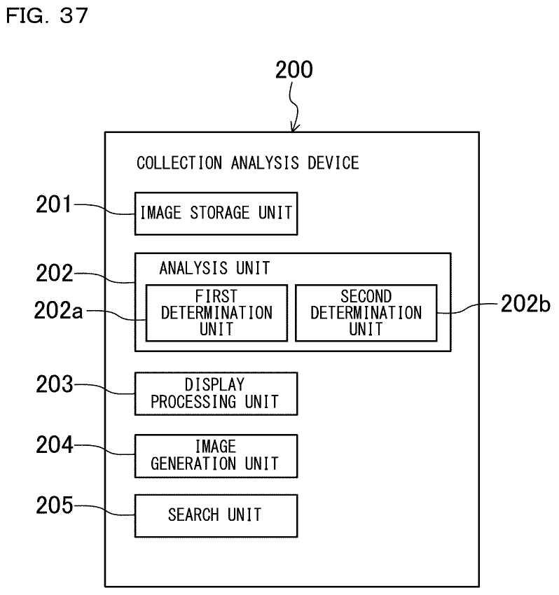

As illustrated in FIG. 37, the collection and analysis device 200 includes an analysis unit 202 that estimates the error cause, and the analysis unit 202 is realized by a processor (for example, a GPU). Based on the result of the decoding processing corresponding to each workpiece ID, the analysis unit 202 specifies the workpiece IDs associated with the image for which reading has failed as error workpiece IDs, and keeps the workpiece IDs associated with the other images, that is, the images for which reading has succeeded as it is. As a result, the analysis unit 202 can automatically classify the images associated with the error workpiece IDs and the other images. In addition, the analysis unit 202 estimates the error cause based on the plurality of images associated with the error workpiece IDs.

Specifically, the analysis unit 202 includes a first determination unit 202a that determines whether or not there is a code by using the images associated with the error workpiece IDs, and a second determination unit 202b that determines whether or not there is a workpiece by using the images associated with the error workpiece IDs. The first determination unit 202a is a unit that specifies the code region based on the images associated with the error workpiece IDs and detects the code from the specified code region, and can determine whether or not there is the code by processing similar to the code detection unit 43, for example. In a case where the code is detected in at least one image associated with the error workpiece ID, the first determination unit 202a determines that a code is given to the workpiece W associated with the error workpiece ID.

The first determination unit 202a has a machine learning model trained in advance from a plurality of code images, and is configured to determine whether or not there is a code in an image corresponding to the error workpiece ID by the machine learning model. Since the code itself does not greatly change for each user, the code detection can be trained in advance to save the time and effort of the user, unlike the detection of the workpiece W. For example, a machine learning model using a convolutional neural network (CNN) can be adopted as the machine learning model of the first determination unit 202a. Note that, the first determination unit 202a may perform detection based on rules.

In a case where the workpiece W is detected in at least one image associated with the error workpiece ID, the second determination unit 202b determines that the workpiece W corresponding to the error workpiece ID has been normally conveyed. It can also be determined that the workpiece W has not been conveyed based on the determination result of the second determination unit 202b. The second determination unit 202b has a machine learning model trained from a conveyance device image (conveyor image) captured in a state where the workpiece W is not included in the field of view by the plurality of code readers 1 installed around the conveyance device B. For example, the code reader 1 can acquire a background image obtained by capturing the conveyance device B in a state where the workpiece W is not included in the field of view. The machine learning model can be trained by inputting the background image as a learning image to the machine learning model. For example, a machine learning model using a convolutional neural network (CNN) can be adopted as the machine learning model of the second determination unit 202b. For example, after only the background image is learned, the second determination unit 202b detects a difference (that is, the workpiece on the conveyance device B) between a characteristic of the background image and a characteristic of the image input at the time of operation. In addition, the second determination unit 202b may learn not only the background image but also an image on which the workpiece W appears on the conveyance device B. As a result, in a case where variations in an appearance, a size, and the like of the workpiece W to be conveyed is small, the determination accuracy as to whether or not there is the workpiece can be improved.

The second determination unit 202b determines whether or not there is the workpiece W for the image corresponding to the error workpiece ID by the machine learning model. The image corresponding to the error workpiece ID is input to the machine learning model of the second determination unit 202b, and thus, it is possible to accurately determine whether or not there is the workpiece W in the image. The machine learning model of the second determination unit 202b is trained by the conveyance device image corresponding to the installation situation of the conveyance device B and the code reader 1 used by the user, and thus, the machine learning model is hardly affected by a scratch of the conveyance device B and a change in an exposure timing, and the detection accuracy of the workpiece W is improved.

The second determination unit 202b is configured to be able to train the machine learning model of the second determination unit 202b with a new conveyance device image at a predetermined time interval or at a timing designated by the user. That is, since the conveyance device B deteriorates with the lapse of time, it is possible to perform detection corresponding to a current situation of the conveyance device B by periodically retraining and additionally training the machine learning model of the second determination unit 202b, and erroneous determination is less likely to occur. The predetermined time interval is, for example, an interval of several days, an interval of several weeks, an interval of several months, or the like. Note that, the second determination unit 202b may perform detection based on rules.

The analysis unit 202 estimates the error cause for each error workpiece ID using the first determination unit 202a and the second determination unit 202b. The order of determination by the analysis unit 202 can also be specified. For example, the analysis unit 202 determines whether or not there is the workpiece W by the second determination unit 202b for the image for which it is determined that there is no code by the first determination unit 202a among the images associated with the error workpiece IDs. Note that, the determination of the first determination unit 202a may be performed after the determination of the second determination unit 202b, but a processing time can be shortened by performing the determination of the second determination unit 202b after the determination of the first determination unit 202a. For example, when there is the code, there is the workpiece W, but even though there is the workpiece W, it is not known whether the code is given. Therefore, in a case where the code can be detected, it is determined that there is also the workpiece W, and the processing time can be shortened by terminating the processing.

The error cause includes a first type in which reading of an image in which there is a code, among the images associated with the error workpiece IDs, has failed and a second type in which a workpiece W corresponding to the error workpiece ID of an image in which there is no code, among the images associated with the error workpiece IDs, is normally conveyed. When it is determined which one of the first type and the second type the error cause belongs to, the determination result of the first determination unit 202a and the determination result of the second determination unit 202b can be used. As a result, it is possible to specify whether the error cause is due to the code itself or due to the fact that the code is not given to the workpiece W. For example, assuming a case where about eight code readers 1 are installed, in a case where five images per workpiece W are captured, since the number of images per workpiece W is 40, it is burdensome for the user to confirm the images one by one. However, it is determined which one of the first type and the second type the error cause belongs to and presenting the determination result to the user, and thus, it is easier for the user to take a measure against the error.

The error cause may include a third type in which there is no workpiece W corresponding to the error workpiece ID or this workpiece is not normally conveyed. For example, a determination result of the second determination unit 202b can be used to determine whether or not the error cause belongs to the third type. The third type is included in the error cause, and thus, it is possible to specify whether or not the workpiece W itself has not entered the field of view of the capturing unit 3. As a result, the user can more easily take a measure against the error. As an example in which the error cause belongs to the third type, in a case where a position or a conveyance speed of a certain object detected by the workpiece sensor 92 or the encoder 91 does not correspond to the time of the code reader 1 due to some cause including a defect of a program or a machine failure, there is a possibility that the workpiece W cannot be captured. In addition, a case where only the workpiece ID is generated although the workpiece W is not conveyed due to a malfunction of the workpiece sensor 92 or the encoder 91 can also be the example in which the error cause belongs to the third type.

The analysis unit 202 can set the number of images for which decoding processing has succeeded, among the plurality of images associated with the workpiece IDs, as a threshold value for determining that the workpiece ID is the workpiece ID for which reading has succeeded. In a case where the number of images for which decoding processing has succeeded is equal to or larger than a predetermined number, the workpiece ID of the workpiece W is set as the successfully read workpiece ID. The analysis unit 202 is configured to vary the number of images serving as the threshold value for determining that the workpiece ID is the workpiece ID for which reaching has succeeded. Since the number of images serving as the threshold value can be changed, a level of reading stability can be adjusted. For example, when there are a plurality of codes, the determination may be performed separately in units of types of codes, or may be performed in units of workpieces. When even one of the plurality of types of codes does not exceed the threshold value, the workpiece W can be determined as a reading failure. In addition, for example, in a case where one workpiece W have five decoding opportunities, in a case where decoding of two types out of three types succeeds five times, even though decoding of one type succeeds only once, reading stability is low, and thus, it can be determined that reading has failed.

The collection and analysis device 200 includes a display processing unit 203, and the display processing unit 203 is realized by a processor. The display processing unit 203 acquires the error cause estimated by the analysis unit 202 together with the error workpiece ID, and displays, on the display unit 301, the image associated with the error workpiece ID together with the error cause corresponding to the acquired error workpiece ID. The display unit 301 may be a display device that can be installed away from a body portion of the setting device 300, or may be integrated with the body portion of the setting device 300.

The collection and analysis device 200 includes an image generation unit 204. The image generation unit 204 is a unit that generates a packing style image indicating the appearance of the workpiece W by combining the plurality of images associated with each workpiece ID. The packing style image may be generated by the collection and analysis device 200 or may be generated by the control unit 4 of the code reader 1.

When the workpiece W being conveyed by the conveyance device B is captured multiple times at constant time intervals (constant distance intervals) by the capturing unit 3, partial images of the workpiece W sequentially captured from a portion of the workpiece W on the upstream side to a portion on the downstream side in the conveyance direction are generated. Since these partial images are images obtained by capturing the same workpiece W, these partial images are associated with the same workpiece ID. The image generation unit 204 generates one packing style image by combining a plurality of partial images associated with the same workpiece ID so as to be arranged in order of capturing. An internal time such as an internal clock of the code reader 1 is added to date and time information based on a capturing date and time of the image used to generate the packing style image. Here, the collection and analysis device 200 can convert the date and time information of the image into an external time by receiving a correspondence between the internal time of the code reader 1 and the external time such as UTC from the controller 100.

When the image generation unit 204 generates the packing style image, the generated packing style image is transmitted to the image storage unit 201. The image storage unit 201 stores the packing style image generated by the image generation unit 204 in association with the corresponding workpiece ID. At this time, the image storage unit 201 stores the packing style image together with the date and time information based on the capturing date and time of the image used to generate the packing style image. The date and time information stored in the image storage unit 201 is also associated with the workpiece ID.

In addition, in a case where the plurality of code readers 1 are used, the image generation unit 204 generates the packing style image for each code reader 1. For example, the image generation unit 204 extracts a plurality of images corresponding to each workpiece W for each code reader 1 of the plurality of code readers 1. At this time, the plurality of images corresponding to each workpiece W can be extracted based on the workpiece ID. The image generation unit 204 can generate the packing style image of each workpiece W by combining the plurality of extracted images.

The packing style image of each code reader 1 generated by the image generation unit 204 is stored in the image storage unit 201 in association with the corresponding workpiece ID. At this time, each packing style image can be stored in the image storage unit 201 in a state of being associated with specific information for specifying the captured code reader 1. Even though the packing style image corresponding to each workpiece is generated for each code reader 1 of the plurality of code readers 1, each packing style image can be stored in the image storage unit 201.

The code reader system S further includes a search unit 205 that searches for the packing style image from the date and time information designated by the user, and the search unit 205 is realized by a processor. The search unit 205 may be provided in the collection and analysis device 200 or may be provided in the setting device 300. When the user designates the date and time information by operating the operation unit 302 of the setting device 300, for example, the designated date and time information is accepted by the search unit 205. When the date and time information is accepted, the search unit 205 searches for the packing style image combined by images captured at the capturing date and time specified by the date and time information from among a plurality of packing style images stored in the image storage unit 201. The display processing unit 203 displays the searched packing style image on the display unit 301. At this time, the workpiece ID associated with the packing style image may be displayed on the display unit 301. The code reader system S has a storage and search function of the packing style image, for example, and thus, when there is an inquiry about damage of the workpiece W from a person who finally holds the workpiece W after conveyance, it is possible to confirm later at what timing and in what situation the workpiece W has been.

In addition, the search unit 205 can also search for the packing style image from the workpiece ID. When the user operates the operation unit 302 of the setting device 300 to input the workpiece ID, the input workpiece ID is accepted by the search unit 205. When the workpiece ID is accepted, the search unit 205 searches for the packing style image specified by the workpiece ID from among the plurality of packing style images stored in the image storage unit 201. The display processing unit 203 displays the searched packing style image on the display unit 301.

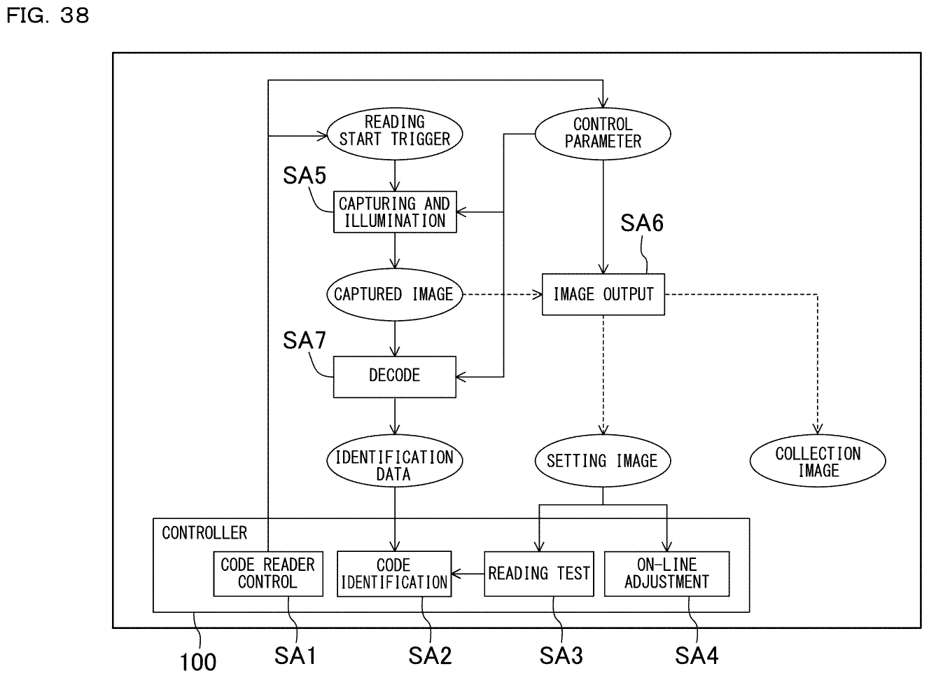

FIG. 38 is a flowchart illustrating an example of a flow of processing from capturing to image storage. The controller 100 executes code reader control processing (step SA1) for controlling the code reader 1, code identification processing (step SA2) for identifying the code, reading test processing (step SA3) for executing a code reading test, and online adjustment processing (step SA4) at the time of operation. First, the controller 100 executes code reader control processing SA1 and transmits a reading start trigger signal and a control parameter to the code reader 1. The code reader 1 having received the reading start trigger signal executes illumination and capturing processing in step SA5. The captured image is generated by performing step SA5. The captured image is transmitted, as the setting image, to the controller 100 by executing image output processing in step SA6. The controller 100 executes the reading test processing in step SA3 and the online adjustment processing in step SA4 based on the setting image. In addition, the captured image is transmitted, as the collection image, to the collection and analysis device 200 and is stored in the image storage unit 201.

In step SA7, the decoding unit 44 executes decoding processing on the captured image. Identification data for code identification generated by the decoding processing is transmitted to the controller 100 and is used in the code identification processing in step SA2.

The controller 100, the code reader 1, and the dimension measurement unit 90 have a log function of accumulating logs in each device and outputting the logs to the collection and analysis device 200. The collection and analysis device 200 collects and accumulates the logs output from the controller 100, the code reader 1, and the dimension measurement unit 90.

A format of the log data is not particularly limited, but, for example, a line protocol can be used. The line protocol includes a plurality of fields such as a field indicating a log type, a field of an identifier, a field of log data, and a field of a transmission time. As a result, the collection and analysis device 200 can discriminate when and what type of log was transmitted from which device.

The logs collected and accumulated by the collection and analysis device 200 include a package log, an image collection log, a system log, and the like. The package log is a log for collecting detailed information of the workpiece W in time series. The controller 100 outputs the package log at a timing (release point) at which the tracking of the workpiece W is ended. The image collection log is an image generated by the capturing unit 3 described above, and the controller 100 outputs, as the image collection log, the image generated by the capturing unit 3. The system log is a log related to a state change of the entire system or an event, and includes logs output from not only the controller 100 but also the code reader 1 and the dimension measurement unit 90.

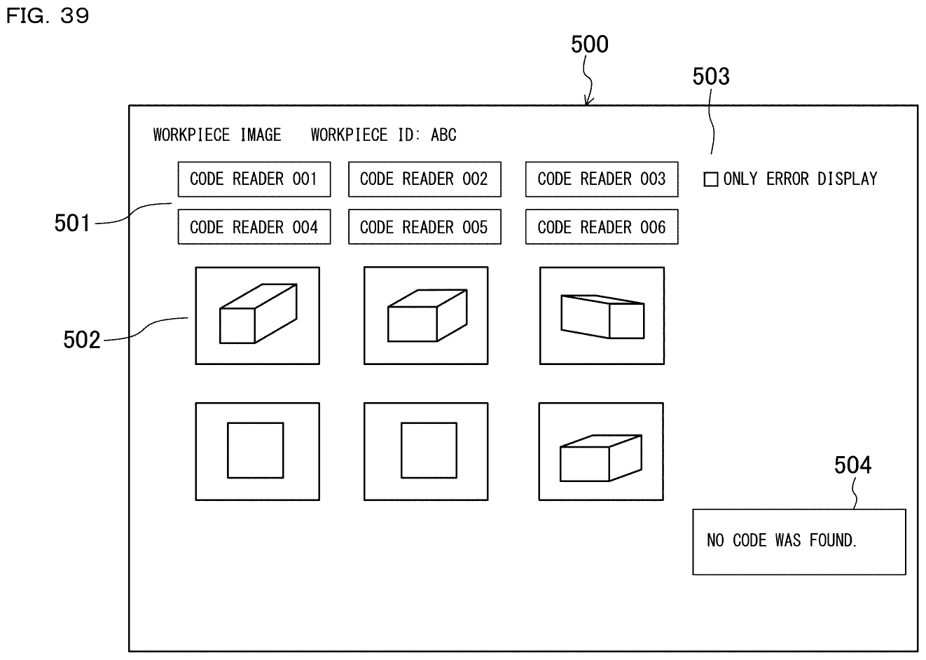

FIG. 39 illustrates an image displaying user interface screen 500 displayed on the display unit 301 by the display processing unit 203. A code reader display region 501, a workpiece image display region 502, and a check box 503 for displaying only an error are provided in the image displaying user interface screen 500. In the example illustrated in FIG. 39, six code readers 001 to 006 are used as the code readers in operation, and the six code readers 001 to 006 are displayed in the code reader display region 501. In the workpiece image display region 502, packing style images based on images captured by the six code readers 001 to 006 are displayed. The packing style images displayed in the workpiece image display region 502 are thumbnail images, and a calculation load is reduced by displaying the thumbnail images. The code reader 1 is not limited to the configuration including one capturing unit 3 illustrated in FIG. 5, and may include a plurality of capturing units 3 in the housing of the code reader 1. In the case of this configuration, the code reader display region 501 may indicate that the code reader is used, as a different code reader, for each capturing unit 3 even in a common housing, and the workpiece image display region 502 may display the packing style image based on the image captured by each capturing unit 3.

In this example, since the six code readers 001 to 006 capture the workpiece W from different directions, the packing style images displayed in the workpiece image display region 502 are different images. When the user checks the check box 503 for displaying only the error, the search unit 205 detects this checking. Then, the search unit 205 searches for the packing style image corresponding to the error workpiece ID for which reading of the code has failed, and the display processing unit 203 displays only the packing style image corresponding to the error workpiece ID in the workpiece image display region 502.

The display processing unit 203 can display, on the display unit 301, the packing style image corresponding to each workpiece ID and the error cause for each workpiece ID. That is, an error cause display region 504 that displays the error cause is provided in the image displaying user interface screen 500. In the error cause display region 504, an analysis result by the analysis unit 202 is displayed. For example, in a case where the analysis unit 202 determines that there is no code, a message or the like indicating that there is no code is displayed in the error cause display region 504. In addition, in a case where the analysis unit 202 determines that there is no workpiece W, a message or the like indicating that there is no workpiece W is displayed in the error cause display region 504. As described above, the packing style image indicating the appearance of the workpiece W is displayed together with the error cause, and thus, it is easier for the user to solve the error.

The display processing unit 203 can display, on the display unit 301, statistical information based on error causes corresponding to a plurality of error workpiece IDs. The statistical information includes, for example, an overall reading success rate, an effective reading rate excluding errors not caused by the code reader, and a breakdown of errors not caused by the code reader. The breakdown includes, for example, an error caused by the absence of the workpiece itself, an error caused by the damage to the workpiece, and the like.

The display processing unit 203 can also display, on the display unit 301, the packing style image corresponding to the error workpiece ID for which reading of the code has failed and the packing style images corresponding to other workpiece IDs in a comparable aspect. The “other workpiece IDs” includes a workpiece ID for which reading of a code has succeeded. For example, the display processing unit 203 generates the image displaying user interface screen, and provides a region where the packing style image corresponding to the error workpiece ID is displayed and a region where the packing style images corresponding to other workpiece IDs are displayed on the image displaying user interface screen. The display processing unit 203 displays the image displaying user interface screen on the display unit 301, and thus, the user can view and compare the packing style image for which the reading of the code has failed with the packing style image for which the reading of the code has succeeded. As a result, it is easy to visually identify the error cause.

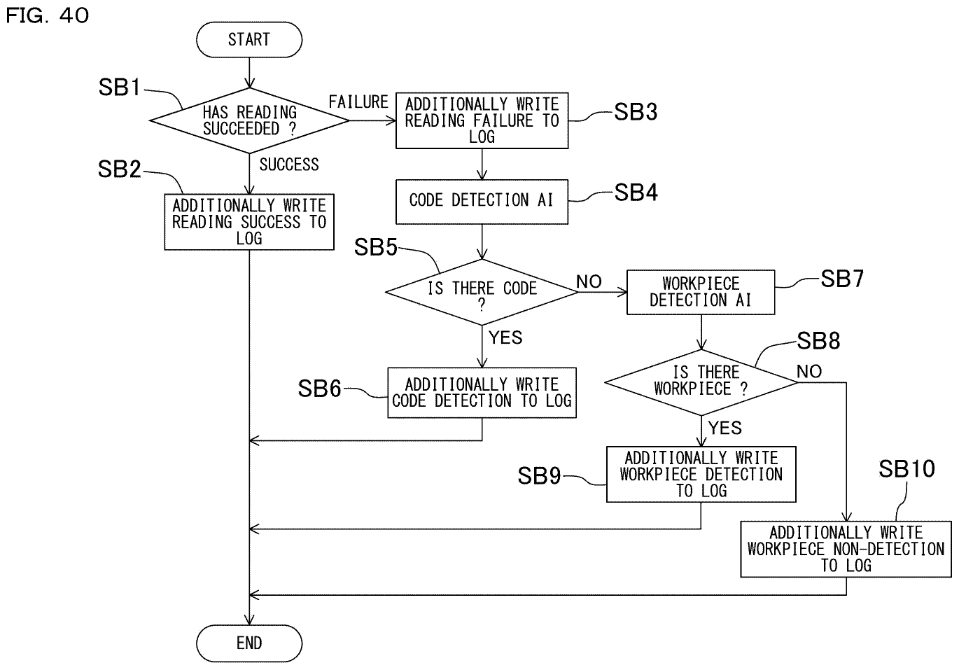

FIG. 40 is a flowchart illustrating a procedure until the log is additionally written after the decoding processing. In step SB1 after the start, the collection and analysis device 200 determines whether or not the reading of the code has succeeded. Whether or not the reading of the code has succeeded is determined based on the result of the decoding processing. In addition, in a case where a distance between adjacent workpieces W is narrower than a predetermined interval, since there is a high risk that the information read in the decoding processing is associated with an incorrect workpiece, it may be considered that the reading has failed regardless of the result of the decoding processing.

In a case where the reading of the code has succeeded, the processing proceeds to step SB2, and the fact that the reading of the code has succeeded is additionally written to the log and the processing is ended. “Being additionally written” means that the collection and analysis device 200 stores the log. In a case where the reading of the code has failed (step SB3), the fact that the reading of the code has failed is additionally written to the log, and the processing proceeds to step SB4.

In step SB4, the first determination unit (code detection AI) 202a of the analysis unit 202 executes processing of determining whether or not there is the code. In step SB5, the presence or absence of the code is determined. In a case where there is the code, the processing proceeds to step SB6, and the presence of the code is additionally written to the log, and the processing is ended. In a case where there is no code, the processing proceeds to step SB7. In step SB7, the second determination unit (workpiece detection AI) 202b of the analysis unit 202 executes processing of determining whether or not there is the workpiece W. In step SB8, the presence or absence of the workpiece W is determined. In a case where there is the workpiece W, the processing proceeds to step SB9, and the presence of the workpiece W is additionally written in the log, and the processing is ended. In a case where there is no workpiece W, the processing proceeds to step SB10, and the absence of the workpiece W is additionally written to the log, and the processing is ended. A method for estimating the error cause based on the additionally written log is as described above. Note that, in a case where there is the workpiece W, it may be determined whether the workpiece W is a box-shaped workpiece or a bag-shaped workpiece, or whether or not the workpiece W is scratched.

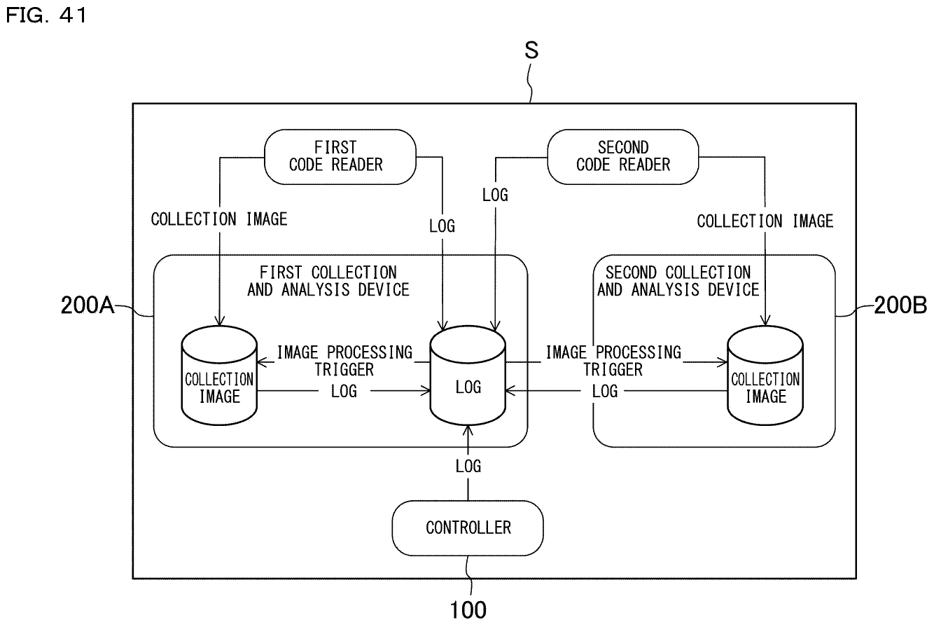

In addition, as illustrated in FIG. 41, the code reader system S may include a plurality of collection and analysis devices 200A and 200B. In the case illustrated in FIG. 41, a first collection and analysis device 200A and a second collection and analysis device 200B constitute image storage devices, respectively, and a plurality of images and logs captured by the plurality of code readers 1 are stored in a distributed manner in the plurality of collection and analysis devices 200A and 200B. For example, when an image data size per sheet increases, a processing load increases accordingly, and thus, there is a concern that storage processing is delayed in one collection and analysis device 200. In such a case, the plurality of images are stored in a distribution manner in the plurality of collection and analysis devices 200A and 200B, and thus, the processing load can be distributed to the plurality of collection and analysis devices 200A and 200B. As a result, the delay of the storage processing can be eliminated. The collection and analysis devices 200A and 200B may be provided for each code reader 1, or may be provided for each set of a plurality of code readers 1. In addition, the plurality of images sequentially generated by the code reader 1 may be distributed and stored in the plurality of collection and analysis devices 200A and 200B in the generation order. The number of collection and analysis devices 200 is not limited to two.

In a case where the plurality of collection and analysis devices 200A and 200B are provided, the analysis unit 202 can acquire a plurality of images related to the error workpiece ID stored in a distributed manner in the plurality of collection and analysis devices 200A and 200B, and can estimate the error cause based on the acquired images.

The first collection and analysis device 200A may be a primary collection and analysis device, and the second collection and analysis device 200B may be a secondary collection and analysis device. In this case, the first collection and analysis device 200A executes main functions such as generation of a log display screen and collection of logs. At a log acquisition timing, the first collection and analysis device 200A transmits an image processing trigger signal to the second collection and analysis device 200B.

The second collection and analysis device 200B collects and stores the image output from the code reader 1, but stops main functions such as the generation of the log display screen and the collection of the logs. When the image processing trigger signal is received from the first collection and analysis device 200A, the second collection and analysis device 200B executes processing of generating the packing style image and processing of automatically classifying images. In addition, the log data of the first collection and analysis device 200A is updated based on the analysis result of the analysis unit 202.

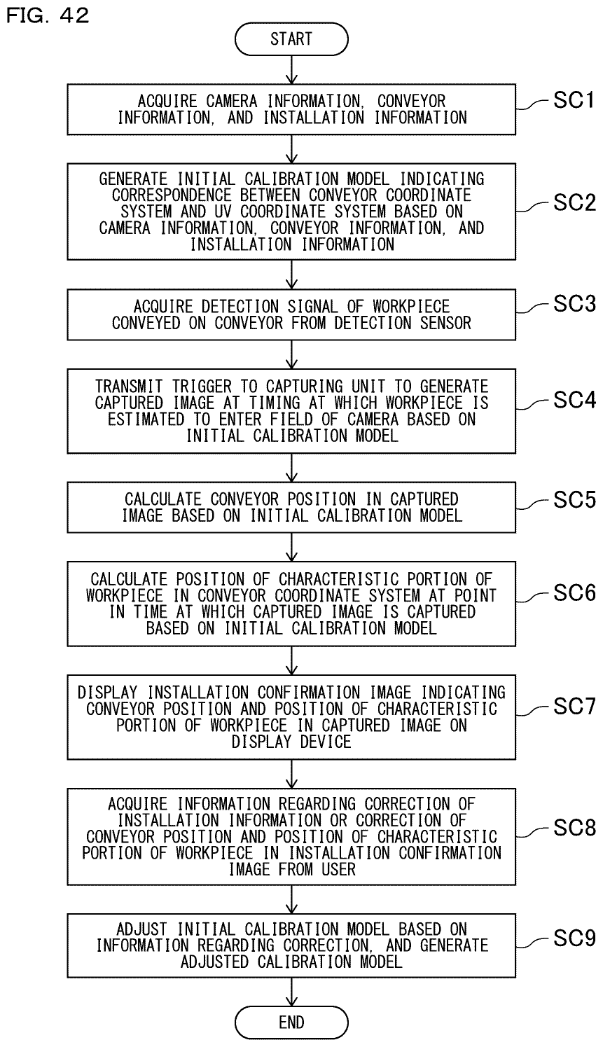

FIG. 42 is a control flowchart of the controller 100 when the above-described generation and adjustment of the calibration model of the code reader system S are executed. Details of each step correspond to the description in the above-described embodiment.

In step SC1 after the start, the controller 100 acquires the camera information, the conveyor information, and the installation information. In step SC2, the controller 100 generates an initial calibration model indicating a correspondence between the conveyor coordinate system and the UV coordinate system based on the camera information, the conveyor information, and the installation information. After the initial calibration model is generated, the calibration model is adjusted by conveying the workpiece W on the conveyor.

In step SC3, the controller 100 acquires the detection signal of the workpiece W conveyed on the conveyor from the detection sensor 92. In step SC4, the controller 100 transmits a trigger to the capturing unit 3 at a timing at which the workpiece W is estimated to enter the field of view of the camera based on the initial calibration model to generate the captured image. In step SC5, the controller 100 calculates the conveyor position in the captured image based on the initial calibration model. In step SC6, the controller 100 calculates the position of the characteristic portion of the workpiece W in the conveyor coordinate system at a point in time at which the captured image is captured based on the initial calibration model. In step SC7, the controller 100 displays, on the display device, the installation confirmation image indicating the conveyor position M and the position of the characteristic portion of the workpiece W in the captured image. In step SC8, the controller 100 acquires information regarding correction of the installation information or correction of the conveyor position and the position of the characteristic portion of the workpiece in the installation confirmation image from the user. Here, an example in which the conveyor position and the position of the characteristic portion of the workpiece W are displayed in the same captured image is illustrated, but the invention is not limited thereto. That is, after parameters other than the conveyance direction are adjusted by the captured image of only the conveyor not including the workpiece W, parameters in the conveyance direction may be adjusted by another captured image including the workpiece W conveyed on the conveyor.

In step SC9, the controller 100 adjusts the initial calibration model based on the information regarding the correction acquired in step SC8, generates the adjusted calibration model, and ends the generation and adjustment of the calibration model.

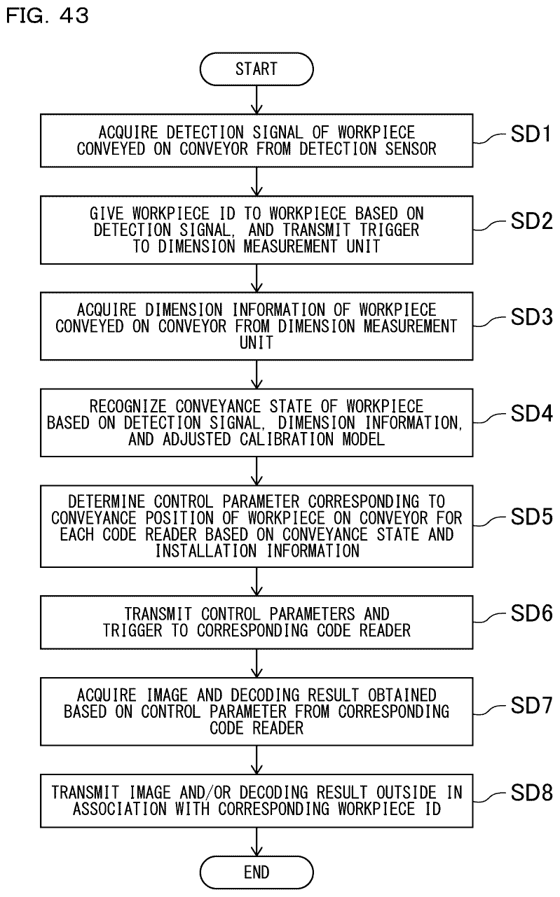

FIG. 43 is a control flowchart of the controller 100 from when the code reader system S detects one workpiece to when the read result is transmitted to the outside by using the adjusted calibration model generated in FIG. 42. Details of each step correspond to the description in the above-described embodiment.

In step SD1 after the start, the controller 100 acquires the detection signal of the workpiece W conveyed on the conveyor from the detection sensor 92. In step SD2, the controller 100 gives the workpiece ID to the workpiece W based on the detection signal, and transmits a trigger to the dimension measurement unit 90. In step SD3, the controller 100 acquires dimension information of the workpiece W conveyed on the conveyor from the dimension measurement unit 90. In step SD4, the controller 100 recognizes the conveyance state of the workpiece W based on the detection signal, the dimensional information, and the adjusted calibration model. In step SD5, the controller 100 determines the control parameter corresponding to the conveyance position of the workpiece W on the conveyor for each code reader 1 based on the conveyance state and the installation information. In step SD6, the controller 100 transmits the control parameter and the trigger to the corresponding code reader 1. In step SD7, the controller 100 acquires the image and the decoding result obtained based on the control parameter from the corresponding code reader 1. In step SD8, the controller 100 transmits the image and/or the decoding result to the outside (the data communication device 93, the collection and analysis device 200, and the setting device 300) in association with the corresponding workpiece ID, and ends the control flow for one workpiece W. Then, the code reader system S repeats the above-described flow for each workpiece W sequentially conveyed on the conveyor.

The above-described embodiment is merely an example in all respects, and should not be construed in a limiting manner. Further, all modifications and changes falling within the equivalent scope of the claims are within the scope of the invention. In this embodiment, it has been described that the code reader 1 and the controller 100 are physically separated, but a part of the controller 100 may be incorporated in the code reader 1. For example, the acquisition unit 101, the control unit 107, and the display processing unit 108 of the controller 100 are incorporated into the code reader 1, and thus, the code reader 1 can include the acquisition unit 101, the control unit 107, and the display processing unit 108.

Problems different from the above problems will be described. That is, for example, a code reader is configured to capture a code such as a barcode or a two-dimensional code attached to a workpiece conveyed by a conveyor by a camera, cut out the code included in the obtained image by image processing, binarize the code, perform decoding processing, and read information (see, for example, JP2021-149604A).

The code reader of JP2021-149604A is configured to be able to acquire camera information including a camera parameter, code information to be read, and environment information indicating a reading environment, determine a recommended installation position that satisfies a required field of view and a depth based on the camera information and the code information, and provide the determined recommended installation position to a user.

Incidentally, for example, when an image processing device such as the code reader is operated, an installation state of the image processing device varies depending on a use environment, a type and a size of the workpiece, and the like. In particular, in a case where it is necessary to accurately associate the workpiece with the decoding result of the code, since highly accurate calibration is required to improve the accuracy, the accuracy of the association may be insufficient only by providing the recommended installation position according to JP2021-149604A.

In the related art, in such a case, the user executes complicated processing by using a programmable logic controller (PLC) or the like, and a burden on the user is large.

A further feature of the disclosure has been made in view of such a point, and an object thereof is to reduce a burden on a user at the time of calibration.

### Clause A1

An image processing device comprising:
a camera that includes an image sensor having a plurality of pixels arrayed in a matrix, and captures a workpiece conveyed on a conveyor by the image sensor to generate a captured image;
an acquisition unit that acquires camera information regarding the camera, installation information indicating a position and a posture of the camera in a conveyor coordinate system of the conveyor, conveyor information including a conveyance speed of the conveyor, and a detection signal of the workpiece; and
a control unit that generates a calibration model indicating a correspondence between the conveyor coordinate system and a UV coordinate system of the image sensor based on the camera information and the installation information,
wherein the control unit
calculates a position of a characteristic portion of the workpiece in the conveyor coordinate system at a point in time at which the captured image is captured based on the detection signal and the conveyance speed, and
adjusts a parameter of the calibration model in a conveyance direction based on the position corresponding to the characteristic portion in the conveyor coordinate system and a position corresponding to the characteristic portion in the UV coordinate system of the captured image.

### Clause A2

The image processing device according to Clause A1, wherein
the acquisition unit acquires the detection signal of the workpiece by a detection sensor installed on an upstream side of the conveyor with respect to the camera, and
the control unit defines the conveyor coordinate system with a position of the detection sensor as a reference, and calculates the position of the characteristic portion based on an elapsed time from the detection of the workpiece to the point in time at which capturing is performed.

### Clause A3

The image processing device according to Clause A2, wherein
the control unit
recognizes a conveyance state of the workpiece conveyed on the conveyor based on the detection signal and the conveyance speed at the time of operation after adjustment of the parameter of the calibration model, and determines at least one of a first partial region where a signal is read from the image sensor and a second partial region where image processing is executed on the captured image based on the conveyance state and the adjusted calibration model.

### Clause A4

The image processing device according to Clause A3, wherein, in a case where a target workpiece to be captured and an adjacent workpiece adjacent to the target workpiece are included in a field of view of the camera, the control unit determines at least one of the first partial region that includes the target workpiece but does not include the adjacent workpiece and the second partial region that includes the adjacent workpiece on which mask processing is executed.

### Clause A5

The image processing device according to Clause A1, wherein coordinates of the position corresponding to the characteristic portion in the UV coordinate system of the captured image are coordinates designated as the characteristic portion by a user for the captured image or coordinates specified by executing image processing on the captured image.

### Clause A6

The image processing device according to Clause A5, wherein
the acquisition unit
acquires designation from the user with a leading edge of the workpiece as the characteristic portion of the workpiece in a case where the field of view of the camera is directed from a downstream side to an upstream side of the conveyor, and
acquires designation from the user with a trailing edge of the workpiece as the characteristic portion of the workpiece in a case where the field of view of the camera is directed from the upstream side to the downstream side of the conveyor.

### Clause A7

The image processing device according to Clause A5, wherein the control unit specifies, as the characteristic portion, an edge portion of the workpiece detected by executing edge detection processing on the captured image.

### Clause A8

The image processing device according to Clause A7, wherein
in a case where the field of view of the camera is directed from the downstream side to the upstream side of the conveyor, the control unit specifies the leading edge of the workpiece as the characteristic portion of the workpiece, and
in a case where the field of view of the camera is directed from the upstream side to the downstream side of the conveyor, the control unit specifies the trailing edge of the workpiece as the characteristic portion of the workpiece.

### Clause A9

The image processing device according to Clause A5, wherein the control unit specifies, as the characteristic portion, a portion detected by executing code detection processing on the captured image.

### Clause A10

The image processing device according to clause A5, wherein the control unit specifies, as the characteristic portion, a portion for which decoding processing has succeeded by executing the decoding processing on the captured image.

### Clause A11

The image processing device according to Clause A1, wherein the control unit adjusts the parameter of the calibration model in the conveyance direction based on the position of the characteristic portion in the conveyor coordinate system and the position corresponding to the characteristic portion in the UV coordinate system of each captured image for each captured image of a plurality of the captured images obtained by the camera capturing the workpiece conveyed by the conveyor multiple times at different timings.

### Clause A12

The image processing device according to Clause A1, wherein
the control unit calculates an installation candidate position of the camera based on at least one of a size of the workpiece, a conveyor width, and code information input from a user, and
the acquisition unit acquires the installation candidate position as the installation information.

### Clause B1

An image processing device comprising:
a camera that includes an image sensor having a plurality of pixels arrayed in a matrix, and captures a workpiece conveyed on a conveyor by the image sensor to generate a captured image;
an acquisition unit that acquires camera information regarding the camera, conveyor information including a width of the conveyor, and installation information indicating a position and a posture of the camera in a conveyor coordinate system of the conveyor;
a control unit that calculates a conveyor position in the captured image based on the camera information, the conveyor information, and the installation information; and
a display processing unit that displays, on a display device, an installation confirmation image indicating the conveyor position in the captured image.

### Clause B2

The image processing device according to Clause B1, wherein
the acquisition unit further acquires a detection signal of the workpiece by a detection sensor and a conveyance speed of the conveyor as and the conveyor information;
the control unit calculates a characteristic portion of the workpiece in the captured image based on the detection signal and the conveyor information; and
the display processing unit displays, on the display device, the installation confirmation image further indicating a position of the characteristic portion of the workpiece.

### Clause B3

The image processing device according to clause B1, wherein the display processing unit displays, on the display device, an image indicating the installation information together with the installation confirmation image.

### Clause B4

The image processing device according to Clause B1, wherein, correction of the installation information is accepted from a user, the display processing unit changes and displays the conveyor position on the installation confirmation image according to the correction.

### Clause B5

The image processing device according to Clause B2, wherein, when correction of the installation information is accepted from a user, the display processing unit changes and displays at least one position of the conveyor position on the installation confirmation image and the characteristic portion of the workpiece according to the correction.

### Clause B6

The image processing device according to Clause B1, wherein, when designation of the conveyor position on the installation confirmation image is accepted from a user via a display screen displayed on the display device, the display processing unit changes and displays content of the installation information according to the designation.

### Clause B7

The image processing device according to Clause B2, wherein, when designation of at least one position of the conveyor position on the installation confirmation image and the characteristic portion of the workpiece is accepted from a user via a display screen displayed on the display device, the display processing unit changes and displays content of the installation information according to the designation.

### Clause B8

The image processing device according to Clause B2, wherein
the display processing unit
displays, as the characteristic portion of the workpiece, a leading edge of the workpiece on the installation confirmation image in a case where a field of view of the camera is directed from a downstream side to an upstream side of the conveyor, and
displays, as the characteristic portion of the workpiece, a trailing edge of the workpiece on the installation confirmation image in a case where the field of view of the camera is directed from the upstream side to the downstream side of the conveyor.

### Clause B9

The image processing device according to Clause B8, wherein the control unit determines an orientation of the field of view of the camera based on an installation angle of the camera in the conveyor coordinate system.

### Clause B10

The image processing device according to Clause B8, wherein the control unit controls the camera such that the characteristic portion of the workpiece is included in the installation confirmation image based on the detection signal and the conveyor information.

### Clause B11

The image processing device according to Clause B9, wherein
the control unit
controls the camera such that a leading edge of the workpiece is included, as the characteristic portion of the workpiece, in the installation confirmation image in a case where a field of view of the camera is directed from a downstream side to an upstream side of the conveyor, and
controls the camera such that a trailing edge of the workpiece is included, as the characteristic portion of the workpiece, in the installation confirmation image in a case where the field of view of the camera is directed from the upstream side to the downstream side of the conveyor.

### Clause B12

The image processing device according to Clause B1, further comprising:
an output unit that outputs an installation confirmation report including the installation confirmation image.

### Clause B13

The image processing device according to clause B12, further comprising:
a decoder that executes decoding processing of a code attached to the workpiece based on the captured image, and
the output unit outputs the installation confirmation report including a reading test result by the decoder together with the installation confirmation image.

### Clause B14

A code reader system that reads a code attached to a workpiece downstream of a detection sensor that detects the workpiece conveyed on a conveyor based on a detection signal from the detection sensor, the code reader system comprising:
a code reader that includes a camera including an image sensor having a plurality of pixels arrayed in a matrix, and capturing the code attached to the workpiece conveyed on the conveyor by the image sensor to generate a captured image and a decoder that executes decoding processing of the code included in the images captured by the camera; and
a controller that includes an acquisition unit that acquires camera information regarding the camera, conveyor information including a width of the conveyor, and installation information indicating a position and a posture of the camera in a conveyor coordinate system of the conveyor, a control unit that calculates a conveyor position in the captured image based on the camera information, the conveyor information, and the installation information, and a display processing unit that displays, on a display device, an installation confirmation image indicating the conveyor position in the captured image.

### Clause B15

A setting assistance apparatus comprising:
a camera that includes an image sensor having a plurality of pixels arrayed in a matrix, and captures a workpiece conveyed on a conveyor by the image sensor to generate a captured image;
an acquisition unit that acquires camera information regarding the camera, conveyor information including a width of the conveyor, and installation information indicating relative position and posture of the camera in a conveyor coordinate system of the conveyor;
a control unit that calculates a conveyor position in the captured image based on the camera information, the conveyor information, and the installation information; and
a display processing unit that displays, on a display device, an installation confirmation image indicating the conveyor position in the captured image.

Problems different from the above problem will be described. For example, a code reader system is configured to capture a code such as a barcode or a two-dimensional code attached to a workpiece conveyed by a conveyor by a camera based on a trigger signal, cut out the code included in the obtained image by image processing, binarize the code, and decode the code by a decoder (see, for example, JP2021-149657A).

The code reader system of JP2021-149657A is configured to be able to retain success or failure information indicating whether or not reading processing by the decoder has succeeded in a state of being associated with a plurality of images captured based on the trigger signal, select a reading result corresponding to any trigger signal from a user in a state where a list of reading results corresponding to a plurality of trigger signals is displayed on a display unit, and present, to the user, an image associated with the selected trigger signal.

Incidentally, in a case where the reading processing by the decoder has not succeeded, that is, in a case where a reading error has occurred, the user desires to estimate the error cause and solve the problem. In this regard, in JP2021-149657A, since the image is retained for each code reader in association with the trigger signal, when the image corresponding to the workpiece in which the reading error has occurred is specified, the image can only be specified from the error occurrence time in units of code readers.

However, what the user wants to solve the error is not in which code reader the error has occurred but in which workpiece the reading error has occurred, and this problem cannot be solved by the code reader system of JP2021-149657A.

The disclosure has been made in view of such a point, and an object of the disclosure is to facilitate estimation of a reading error cause by a user and solution of a reading error by the user.

### Clause C1

A code reader system that reads a code attached to a workpiece downstream of a detection sensor that detects the workpiece conveyed on a conveyor based on a signal from the detection sensor, the code reader system comprising:
a control unit that generates a workpiece ID for each workpiece based on the signal from the detection sensor;
a plurality of cameras that capture the workpiece from a plurality of different directions in response to an instruction from the control unit;
a decoder that executes decoding processing of the code attached to the workpiece for each of a plurality of images captured by the plurality of cameras;
an image storage unit that stores the plurality of images in association with corresponding workpiece IDs; and
an analysis unit that specifies a workpiece ID for which reading has failed as an error workpiece ID based on a result of the decoding processing corresponding to the workpiece ID, and estimates error causes based on the plurality of images associated with the error workpiece ID.

### Clause C2

The code reader system according to clause C1, further comprising:
a display processing unit that displays, on a display device, at least one of the error cause corresponding to the error workpiece ID, the images associated with the error workpiece ID, and statistical information based on error causes corresponding to a plurality of the error workpiece IDs.

### Clause C3

The code reader system according to clause C1, wherein
the analysis unit includes
a first determination unit that determines whether or not there is a code by using the image associated with the error workpiece ID, and
a second determination unit that determines whether or not there is a workpiece by using the image associated with the error workpiece ID, and
the error cause is estimated for each error workpiece ID by using the first determination unit and the second determination unit.

### Clause C4

The code reader system according to clause C3, wherein
the first determination unit determines that a code is given to a workpiece associated with the error workpiece ID in a case where the code is detected in at least one image associated with the error workpiece ID; and
the second determination unit determines that a workpiece corresponding to the error workpiece ID is normally conveyed in a case where the workpiece is detected in at least one image associated with the error workpiece ID.

### Clause C5

The code reader system according to clause C4, wherein the error cause includes a first type in which reading of an image in which there is a code, among images associated with the error workpiece IDs, has failed and a second type in which a workpiece corresponding to the error workpiece ID of an image in which there is no code, among the images associated with the error workpiece ID, is normally conveyed.

### Clause C6

The code reader system according to clause C5, wherein the error cause further includes a third type in which there is no workpiece corresponding to the error workpiece ID or the workpiece is not normally conveyed.

### Clause C7

The code reader system according to clause C3, wherein the analysis unit determines whether or not there is a workpiece by the second determination unit for an image for which it is determined that there is no code by the first determination unit among images associated with the error workpiece IDs.

### Clause C8

The code reader system according to Clause C3, wherein the second determination unit includes a machine learning model trained from a conveyor image captured in a state where the workpiece is not included in a field of view by the plurality of code readers installed around the conveyor, and determines whether or not there is the workpiece for the image corresponding to the error workpiece ID by the machine learning model.

### Clause C9

The code reader system according to Clause C8, wherein the second determination unit is configured to be able to train the machine learning model of the second determination unit with a new conveyor image at a predetermined time interval or at a timing designated by a user.

### Clause C10

The code reader system according to clause C3, wherein the first determination unit includes a machine learning model trained in advance from a plurality of code images, and determines whether or not there is a code for an image corresponding to the error workpiece ID by the machine learning model.

### Clause C11

The code reader system according to Clause C3, wherein the control unit is configured to set the number of images for which the decoding processing has succeeded, among the plurality of images associated with the workpiece IDs, as a threshold value for determining that the workpiece ID is the workpiece ID for which reading has succeeded, and to vary the number of image serving as the threshold value.

### Clause C12

The code reader system according to Clause C2, further comprising an image generation unit that generates a packing style image showing an appearance of a workpiece by combining the plurality of images associated with each workpiece ID,
wherein the image storage unit stores the packing style image in association with a corresponding workpiece ID, and
the display processing unit displays, on the display device, the packing style image corresponding to the workpiece ID and the error cause for each workpiece ID.

### Clause C13

The code reader system according to clause C12, wherein
the image storage unit stores the packing style image together with date and time information based on capturing date and time of the image used to generate the packing style image, and
the code reader system further includes a search unit that searches for the packing style image from the date and time information designated by a user.

### Clause C14

The code reader system according to Clause C12, wherein
the image generation unit extracts and combines a plurality of images corresponding to each workpiece for each code reader of the plurality of code readers to generate a packing style image of each workpiece, and
the display processing unit displays, on the display device, the packing style image corresponding to the error workpiece ID and packing style images corresponding to other workpiece IDs in a comparable aspect.

### Clause C15

The code reader system according to Clause C1, further comprising a plurality of storage devices that store a plurality of images captured by the plurality of cameras in a distribution manner,
wherein the analysis unit estimates the error cause based on the plurality of images related to the error workpiece ID stored in the distributed manner in the plurality of storage devices.

As described above, the invention can be used, for example, at a site where the workpiece is conveyed by the conveyor or the like.

What is claimed is:

1. A controller connected to one or a plurality of cameras that generate images based on reflected light from a code attached to a workpiece conveyed on a conveyor and a decoder that executes decoding processing of the code attached to the workpiece based on images output from the one or plurality of cameras, the controller comprising:
an acquisition unit that acquires a detection signal of the workpiece by a detection sensor, conveyor information including a conveyance speed of the conveyor, and installation information indicating a position and a posture of each camera of the one or plurality of cameras in a conveyor coordinate system;
a recognition unit that recognizes a conveyance state of the workpiece based on the detection signal and the conveyance speed;
a processing determination unit that determines a control parameter corresponding to a conveyance position of the workpiece on the conveyor for each camera based on the conveyance state and the installation information of each camera; and
a communication unit that transmits the control parameter determined by the processing determination unit to each corresponding camera.

2. The controller according to claim 1, wherein
the processing determination unit determines a capturing cycle for each camera based on the conveyance state and the installation information of each camera, and
the communication unit transmits the capturing cycle determined by the processing determination unit to each corresponding camera.

3. The controller according to claim 1, wherein
the controller is connected to a plurality of illumination units corresponding to the plurality of cameras via the communication unit,
the processing determination unit generates a reference signal that defines a basic cycle common to each camera and each illumination unit, and determines a capturing cycle and an illumination cycle based on the basic cycle for each camera and each illumination unit, and
the communication unit transmits the capturing cycle determined by the processing determination unit to each corresponding camera, and transmits the illumination cycle determined by the processing determination unit to each corresponding illumination unit.

4. The controller according to claim 3, wherein the capturing cycle and the illumination cycle are constituted by one or a plurality of the basic cycles.

5. The controller according to claim 3, wherein the processing determination unit determines offset amounts by which start timings of the capturing cycle and the illumination cycle are offset from the reference signal for each camera and each illumination unit based on the conveyance state and the installation information of each camera.

6. The controller according to claim 1, wherein the plurality of cameras capture a portion above a conveyance surface of the conveyor, and capture different workpiece surfaces.

7. The controller according to claim 5, further comprising an acceptance unit capable of accepting, from a user, a combination of a camera and an illumination unit that are desired to prevent interference among the plurality of cameras and the plurality of illumination units connected to the controller,
wherein the processing determination unit generates a plurality of groups for each combination accepted by the acceptance unit, and determines the offset amount for each group.

8. The controller according to claim 1, wherein the controller is connected to a plurality of bottom-surface cameras that read a common gap of a conveyor from below a conveyance surface of the conveyor and a plurality of illumination units corresponding to the plurality of bottom-surface cameras, and causes the plurality of illumination units to emit illumination light rays at overlapping timings.

9. The controller according to claim 1, wherein
the processing determination unit determines in advance the control parameter corresponding to the conveyance position of the workpiece on the conveyor based on the conveyance state and the installation information of each camera before the workpiece reaches the conveyance position, and
the communication unit transmits the corresponding control parameter to each camera after the corresponding control parameter is determined.

10. The controller according to claim 1, wherein the processing determination unit determines, as the control parameter, a reading region based on the conveyance state and the installation information of each camera for each capturing cycle.

11. The controller according to claim 1, wherein the processing determination unit determines, as the control parameter, a code to be read based on the conveyance state and the installation information of each camera for each capturing cycle.

12. The controller according to claim 1, wherein the processing determination unit determines, as the control parameter, a time limit of decoding processing based on the conveyance state and the installation information of each camera for each capturing cycle.

13. The controller according to claim 1, wherein the processing determination unit determines, as the control parameter, whether or not a captured image is output based on the conveyance speed for each capturing cycle.

14. The controller according to claim 1, wherein
the detection sensor includes a dimension measurement function that further detects workpiece information including at least one of a position of the workpiece in a conveyor width direction and a height of the workpiece, or a dimension measurement unit, separate from the detection sensor, that detects the workpiece information,
the acquisition unit further acquires a width of the conveyor as the conveyor information, and
the processing determination unit determines the control parameter corresponding to the conveyance position of the workpiece on the conveyor in the conveyor width direction based on the workpiece information.

15. The controller according to claim 14, wherein the processing determination unit determines, as the control parameter, a mask region for which decoding processing is not executed based on the conveyance state, the workpiece information, and the installation information of each camera for each capturing cycle.

16. The controller according to claim 1, wherein
the one or plurality of cameras include an image sensor in which a plurality of pixels are arrayed in a matrix and the number of pixels in a column direction is larger than the number of pixels in a row direction, and
the processing determination unit determines, as the control parameter, a region where only pixels arrayed in some rows of the image sensor are partially read based on the conveyance state and the installation information of each camera for each capturing cycle.

17. A controller connected to one or a plurality of code readers, each of the code readers including an illumination control unit that controls an illumination unit that irradiates a workpiece conveyed on a conveyor, a camera that generates images based on reflected light from a code attached to the workpiece, and a decoder that executes decoding processing of the code attached to the workpiece based on the images output from the camera, and the controller controlling the code reader, the controller comprising:
an acquisition unit that acquires a detection signal of the workpiece by a detection sensor, a conveyance speed of the conveyor, and installation information indicating a position and a posture of each code reader of the one or plurality of code readers in a conveyor coordinate system of the conveyor;
a recognition unit that recognizes a conveyance state of the workpiece based on the detection signal and the conveyance speed;
a processing determination unit that determines a control parameter corresponding to a conveyance position of the workpiece on the conveyor for each code reader based on the conveyance state and the installation information of each code reader; and a communication unit that transmits the control parameter determined by the processing determination unit to each corresponding code reader.

18. A code reader system that reads a code attached to a workpiece downstream of a detection sensor that detects the workpiece conveyed on a conveyor based on a detection signal from the detection sensor, the code reader system comprising:
one or a plurality of code readers each including an illumination control unit that controls an illumination unit that irradiates the workpiece, a camera that generates images based on reflected light from the workpiece, and a decoder that executes decoding processing of the code attached to the workpiece based on the images generated by the camera; and
a controller that includes an acquisition unit that acquires the detection signal, a conveyance speed of the conveyor, and installation information indicating a position and a posture of each code reader of the one or plurality of code readers in a conveyor coordinate system of the conveyor, a recognition unit that recognizes a conveyance state of the workpiece based on the detection signal and the conveyance speed, a processing determination unit that determines a control parameter corresponding to a conveyance position of the workpiece on the conveyor for each code reader based on the conveyance state and the installation information of each code reader, and a communication unit that transmits the control parameter determined by the processing determination unit to each corresponding code reader.
